(19) United States
(12) Patent Application Publication
(10) Pub. No.: US 2024/0204602 A1
(43) Pub. Date: Jun. 20, 2024

(54) ROTARY ELECTRIC MACHINE

(71) Applicant: DENSO CORPORATION, Kariya-city (JP)

(72) Inventor: YUKI MAWATARI, Kariya-city (JP)

(21) Appl. No.: 18/588,689

(22) Filed: Feb. 27, 2024

Related U.S. Application Data
(63) Continuation of application No. PCT/JP2022/030779, filed on Aug. 12, 2022.

(30) Foreign Application Priority Data
Sep. 3, 2021 (JP) 2021-144252

(51) Int. Cl. H02K 3/50; H02K 1/18; H02K 3/28; H02K 3/34

(52) U.S. Cl. CPC H02K 3/50; H02K 1/187; H02K 3/28; H02K 3/345; H02K 2203/06

(57) ABSTRACT

A rotary electric machine includes a toothless armature having a multiphase armature winding, an armature holder holding the armature, a position restriction member located in a coil end of the armature and restricting movement of the armature winding, and an insulating layer insulating the armature winding from the position restriction member. The armature winding includes winding segments, and each of the winding segments has an annular shape. Each of the winding segments includes intermediate conductor portions separated at a predetermined interval in a circumferential direction of the armature, and crossover portions provided on both ends of the intermediate conductor portions in an axial direction of the armature to connect the intermediate conductor portions. The position restriction member restricts movement of the winding segments attached to the armature holder. The insulating layer is interposed between each of the winding segments and the position restriction member.

### CROSS REFERENCE TO RELATED APPLICATIONS

The present application is a continuation application of International Patent Application No. PCT/JP2022/030779 filed on Aug. 12, 2022, which designated the U.S. and claims the benefit of priority from Japanese Patent Application No. 2021-144252 filed on Sep. 3, 2021. The entire disclosures of all of the above applications are incorporated herein by reference.

### TECHNICAL FIELD

The present disclosure relates to a rotary electric machine.

### BACKGROUND

There is a known conventional rotary electric machine including a field element including a magnet portion having multiple magnetic poles whose polarities alternate in a circumferential direction, and an armature including multiphase armature windings. There is also a known armature having a toothless structure.

### SUMMARY

According to at lease one embodiment of the present disclosure, a rotary electric machine includes a field element, an armature, an armature holder, a position restriction member and an insulating layer. The field element has magnetic poles. The armature has a toothless structure and includes an armature winding being multiphase. The armature holder holds the armature. The position restriction member is a part of the armature holder or fixed to the armature holder. The position restriction member is located on a coil end of the armature and restricting movement of the armature winding. The insulating layer insulates the armature winding from the position restriction member. The armature winding includes winding segments forming phase windings for respective phases. Each of the winding segments has an annular shape and includes a pair of intermediate conductor portions separated at a predetermined interval in a circumferential direction of the armature, and crossover portions provided on one end and another end of the pair of intermediate conductor portions in an axial direction of the armature. The crossover portions connects the pair of intermediate conductor portions to form the annular shape. Different pairs of intermediate conductor portions of the winding segments are arranged in the circumferential direction and close to each other. The position restriction member restricts movement of the winding segments attached to the armature holder. The insulating layer is interposed between each of the winding segments and the position restriction member.

### BRIEF DESCRIPTION OF THE DRAWINGS

The details of one or more embodiments are set forth in the accompanying drawings and the description below. Other features and advantages will be apparent from the description and drawings, and from the claims.

FIG. 1 is a longitudinal cross-sectional view of a rotary electric machine according to a first embodiment;

FIG. 2A is a perspective view illustrating a stator unit;

FIG. 2B is a perspective view illustrating the stator unit without a molded resin;

FIG. 3 is a top view of the stator unit;

FIG. 4A is a cross-sectional view taken along line 4A-4A in FIG. 3;

FIG. 4B is a cross-sectional view taken along line 4B-4B in FIG. 3;

FIG. 5 is an exploded perspective view illustrating a core assembly;

FIG. 6A is a longitudinal cross-sectional view of the core assembly;

FIG. 6B is a transverse cross-sectional view of the core assembly;

FIG. 7 is a perspective view of a position restriction member;

FIG. 8 is a perspective view illustrating a state in which the position restriction member is attached to the core assembly;

FIG. 9A is a perspective view illustrating a winding segment;

FIG. 9B is a perspective view illustrating a winding segment;

FIG. 10A is a perspective view illustrating a configuration of a position restriction member;

FIG. 10B is an exploded perspective view illustrating a configuration of a position restriction member;

FIG. 11A is a longitudinal cross-sectional view of the stator unit;

FIG. 11B is a longitudinal cross-sectional view of the stator unit;

FIG. 12 is a perspective view of a wiring module;

FIG. 13 is an exploded perspective view of the stator unit;

FIG. 14 is a perspective view related to an assembling process of the stator unit;

FIG. 15 is a perspective view related to the assembling process of the stator unit;

FIG. 16 is a perspective view related to the assembling process of the stator unit;

FIG. 17 is a perspective view related to the assembling process of the stator unit;

FIG. 18A is a longitudinal cross-sectional view of the stator unit;

FIG. 18B is a longitudinal cross-sectional view of the stator unit;

FIG. 19A is a perspective view illustrating a stator unit according to a second embodiment;

FIG. 19B is a perspective view illustrating the stator unit without a molded resin according to the second embodiment;

FIG. 20 is a top view of the stator unit;

FIG. 21A is a cross-sectional view taken along line 21A-21A in FIG. 20;

FIG. 21B is a cross-sectional view taken along line 21B-21B in FIG. 20;

FIG. 22 is an exploded perspective view illustrating a core assembly and a position restriction member;

FIG. 23A is a longitudinal cross-sectional view of the stator unit;

FIG. 23B is a longitudinal cross-sectional view of the stator unit;

FIG. 24A is a perspective view illustrating a stator unit according to a third embodiment;

FIG. 24B is a perspective view illustrating the stator unit without a molded resin according to the third embodiment;

FIG. 25A is a longitudinal cross-sectional view of the stator unit;

FIG. 25B is a longitudinal cross-sectional view of the stator unit;

FIG. 26 is an exploded perspective view of the stator unit;

FIG. 27 is an exploded perspective view of the stator unit;

FIG. 28 is a perspective view illustrating a stator unit according to a fourth embodiment;

FIG. 29 is an exploded perspective view illustrating the stator unit from which a position restriction member is separated;

FIG. 30 is a perspective view illustrating a stator unit according to a fifth embodiment;

FIG. 31 is an exploded perspective view illustrating the stator unit from which position restriction members are separated; and

FIG. 32 is a view illustrating a winding segment according to a modification.

### DETAILED DESCRIPTION

To begin with, examples of relevant techniques will be described. A rotary electric machine according to a comparative example includes a field element including a magnet portion having multiple magnetic poles whose polarities alternate in a circumferential direction, and an armature including multiphase armature windings. The armature has a toothless structure. The armature having the toothless structure may cause positional displacement of an armature winding, unlike a configuration in which the armature winding is wound around each tooth of an armature core. Therefore, a winding restriction member (i.e., coil end holder) is attached to a coil end that is an axial end portion of an armature winding to cause the winding restriction member to engage with the armature winding, thereby restricting the displacement of the armature winding.

In a case where the position of the armature winding is restricted by the winding restriction member, the winding restriction member may be formed of metal from the viewpoint of rigidity. However, in a case where the winding restriction member formed of metal is used, the insulation property of the armature winding may be considered to be impaired.

In contrast, according to the present disclosure, a rotary electric machine is capable of appropriately maintaining an insulation state of an armature winding.

According to a first aspect of the present disclosure, a rotary electric machine includes a field element, an armature, an armature holder, a position restriction member and an insulating layer. The field element has magnetic poles. The armature has a toothless structure and includes an armature winding being multiphase. The armature holder holds the armature. The position restriction member is a part of the armature holder or fixed to the armature holder. The position restriction member is located on a coil end of the armature and restricting movement of the armature winding. The insulating layer insulates the armature winding from the position restriction member. The armature winding includes winding segments forming phase windings for respective phases. Each of the winding segments has an annular shape and includes a pair of intermediate conductor portions separated at a predetermined interval in a circumferential direction of the armature, and crossover portions provided on one end and another end of the pair of intermediate conductor portions in an axial direction of the armature. The crossover portions connects the pair of intermediate conductor portions to form the annular shape. Different pairs of intermediate conductor portions of the winding segments are arranged in the circumferential direction and close to each other. The position restriction member restricts movement of the winding segments attached to the armature holder. The insulating layer is interposed between each of the winding segments and the position restriction member.

In the rotary electric machine including the armature having the toothless structure, a structure for fixing the armature winding is required. In this regard, the armature winding can be appropriately fixed by using the armature holder holding the armature and by restricting the movement of the winding segments of the armature winding using the position restriction member that is a portion of the armature holder or a separate member fixed to the armature holder. However, in this case, when a position restriction member formed of metal is used from the viewpoint of rigidity, a concern may arise that the insulation property of the armature winding could be impaired along with contact between the winding segments and the position restriction member. With respect to this concern, the configuration is employed in which the insulating layer is interposed between the winding segments and the position restriction member. Thus, a decrease in the insulation property can be reduced. As a result, the insulation state of the armature winding can be appropriately maintained.

According a second aspect of the present disclosure, the position restriction member on the coil end is inserted into an annular winding segment of the armature winding on an annularly inner side of a crossover portion of the annular winding segment. The insulating layer is interposed between the crossover portion and the position restriction member.

Since the position restriction member on the coil end is inserted into an annular winding segment of the armature winding on an annularly inner side of a crossover portion of the annular winding segment, the movement can be restricted in two different directions in each of the winding segments. For example, in a configuration where the crossover portion extends in the axial direction (a configuration where the crossover portion is unbent in the radial direction), the position restriction member is placed at a position annularly inward of the crossover portion, whereby the circumferential and axial positions can be restricted. In the configuration where the crossover portion is bent to extend in the radial direction, the position restriction member is placed at a position annularly inward of the crossover portion, whereby the circumferential and radial positions can be restricted. The insulating layer is interposed between the crossover portions and the position restriction member, whereby a decrease in the insulation property of the winding segments caused by the position restriction member can also be reduced.

The winding segment is considered to be formed in an annular shape by winding a conductor material a plurality of times on the inner peripheral basis. In this case, in the configuration where the position restriction member is placed at a position annularly inward of each of the crossover portions, tolerance design and the like of the winding segments are facilitated in a case of designing a separation distance (insulation distance) between the crossover portions and the position restriction member.

According a third aspect of the present disclosure, the winding segments of the armature winding include a first winding segment and a second winding segment, the crossover portions on the coil end being different in shape between the first winding segment and the second winding segment. At least one of the first winding segment or the second winding segment is bent in an radial direction of the armature on the coil end. The first winding segment and the second winding segment are overlapped in the circumferential direction. The position restriction member is a common member that commonly restricts movement of the first winding segment and movement of the second winding segment.

Since the first winding segment and the second winding segment are different in shape of the crossover portion on the coil end, the winding segments can be overlapped in the circumferential direction with each other without interfering with each other. In this case, the movements of the first winding segment and the second winding segment can be restricted by the common position restriction member, and thus the number of components can be reduced and the configuration can be simplified.

According a fourth aspect of the present disclosure, the position restriction member is inserted into the first winding segment on an annularly inner side of a crossover portion of the first winding segment. The position restriction member is inserted into the second winding segment on an annularly inner side of a crossover portion of the second winding segment.

In a case where the first winding segment and the second winding segment are overlapped with each other in the circumferential direction while being in the state where at least one of the first winding segment or the second winding segment is bent in the radial direction on the coil end, the crossover portion in the first winding segments and the crossover portion in the second winding segments are arranged close to each other. In view of this point, the position restriction member is inserted into the first winding segment annularly inward of the crossover portion in the first winding segment and inserted into the second winding segment annularly inward of the crossover portion in the second winding segments. As a result, the movements can be easily restricted in a plurality of directions, in each of the winding segments.

According a fifth aspect of the present disclosure, the position restriction member is a separate member from the armature holder and fixed to the armature holder with a fastener. The position restriction member is inserted into the first winding segment on an annularly inner side of a crossover portion of the first winding segment. The position restriction member faces an outer side of a crossover portion of the second winding segment in the axial direction.

The position restriction member provided as the common member is inserted into the the first winding segment annularly inward of the crossover portion of the first winding segment while facing the crossover portion of the second winding segment from the axially outer position with respect to the crossover portion of the second winding segment. In this case, the position restriction member can be attached to the armature while taking into consideration whether the crossover portions of the winding segments are bent or not.

According a sixth aspect of the present disclosure, the position restriction member is a separate member from the armature holder and fixed to the armature holder with a fastener. A crossover portion of the first winding segment is bent in the radial direction on the coil end. A crossover portion of the second winding segment is unbent in the radial direction on the coil end. The position restriction member is inserted into the first winding segment on an annularly inner side of the crossover portion of the first winding segment. The position restriction member faces an annularly outer side of the crossover portion of the second winding segment.

The position restriction member provided as the common member is configured to be inserted into the first winding segment annularly inward of the crossover portion of the first winding segment while facing the annularly outer side of the crossover portion of the second winding segment. In this case, the position restriction member can be attached to the armature while taking into consideration whether the crossover portions of the winding segments are bent or not. The position restriction member can be attached to the armature from the axial direction after the first winding segment and the second winding segment are attached to the armature holder, and a manufacturing operation can be facilitated.

According a seventh aspect of the present disclosure, the crossover portion of the second winding segment has a circumferentially extending portion that extends in the circumferential direction. The position restriction member includes a first portion and a second portion that face, respectively, an annularly outer side and an annularly inner side of the circumferentially extending portion of the crossover portion of the second winding segment.

The second winding segment is a winding segment including the radially unbent crossover portion on a coil end, and is configured such that the circumferentially extending portion of the crossover portion of the second winding segment is sandwiched by the first and second portions of the position restriction member that face, respectively, the annularly outer side and the annularly inner side of the circumferentially extending portion. In this case, the crossover portion of the second winding segment is sandwiched in the axial direction by the position restriction member, and thus axial movement of the second winding segment can be appropriately restricted.

According a eighth aspect of the present disclosure, the position restriction member is a separate member from the armature holder and fixed to the armature holder with a fastener. The position restriction member includes an annular portion having an annular shape. The position restriction member includes a restriction portion and a fixed portion. The restriction portion is provided on one of an inner side and an outer side of the annular portion in a radial direction of the armature and inserted into an annular winding segment of the armature winding on an annularly inner side of a crossover portion of the annular winding segment. The fixed portion is provided on another of the inner side or the outer side of the annular portion in the radial direction and fixed to the armature holder with the fastener.

In the position restriction member provided separately from the armature holder, the restriction portion is placed annularly inward of the crossover portion in the annular winding segment, on one of the radially inner side and the radially outer side of the annular portion. The fixed portion is fixed to the armature holder with the fastener and provided on the other one of the radially inner side and the radially outer side of the annular portion. In this case, the restriction portion for restricting the movement of the winding segments, and the fixed portion mechanically fixed to the armature holder are provided radially inward and outward of the position restriction member and separated from each other. Thus, the position restriction member can be fixed to the armature holder without interfering with restriction on movement of the crossover portions arranged in the circumferential direction. That is, in the position restriction member, for example, if both the restriction portion for restricting movement of the winding segments and the fixed portion are provided at the radially outer positions, a concern may arise that, for example, the restriction portion could become small due to restriction caused by the fixed portion. However, according to the above configuration, the restriction portion can be large and have sufficient strength.

According a ninth aspect of the present disclosure, crossover portions of the winding segments are arranged in the circumferential direction. The position restriction member has an annular shape and faces the crossover portions arranged in the circumferential direction. The rotary electric machine further comprises a wiring module having an annular shape and being electrically connected to each of the winding segments and fixed to the position restriction member.

In the configuration where the crossover portions of the winding segments are arranged in the circumferential direction, the position restriction member having an annular shape faces the crossover portions arranged in the circumferential direction, and the wiring module having the annular shape is fixed to the position restriction member. As a result, the electrical connection between each of the winding segments arranged in the circumferential direction and the wiring module can be suitably achieved while the number of components can be reduced.

According a tenth aspect of the present disclosure, the insulating layer forms a molded resin located on at least one of opposite coil ends of the armature and integrated with a crossover portion of each of the winding segments and the position restriction member. The molded resin is in contact with a region including the crossover portion of each of the winding segment and the position restriction member.

The crossover portions of the winding segments and the position restriction member are integrally subjected to resin-molding in the region including the crossover portions of the winding segments and the position restriction member on at least one of the coil ends in the axial direction. Thus, a molded resin portion is formed by using the same resin material, in the region including the crossover portions of the winding segments and the position restriction member. In this case, the insulating layer can be appropriately formed in a portion facing the position restriction member around the crossover portions of the winding segments (i.e., in a gap between the crossover portions and the position restriction member).

According an eleventh aspect of the present disclosure, the position restriction member includes an annular portion having an annular shape. The annular portion includes a through-hole extending through the annular portion in the axial direction. The molded resin is in contact with a region including an inside of the through-hole and both sides of the annular portion facing in the axial direction.

The through-hole extending in the axial direction is provided in the annular portion of the position restriction member, whereby a flow of a resin material from the axially outer side to the axially inner side of the position restriction member is promoted. As a result, the resin material reliably flows between the crossover portions of the winding segments and the position restriction member, and formation of the resin mold (formation of the insulating layer) can be appropriately performed.

According a twelfth aspect of the present disclosure, the position restriction member has a molding-free portion that is not covered by the molded resin. The molding-free portion faces away from the crossover portion located between the position restriction member and the armature holder and surrounds the crossover portion.

In the position restriction member, the portion of the position restriction member facing away from the crossover portion located between the position restriction member and the armature holder and surrounding the crossover portion is the molding-free portion that is not covered by the molded resin. In this case, the molding-free portion of the position restriction member is exposed to the outside without having been subjected to resin-molding, and heat dissipation performance is improved. For example, in the configuration having an oil cooling structure, the molding-free portion (i.e., exposed portion) of the position restriction member is a heat dissipation portion through which heat is dissipated by oil cooling.

According a thirteenth aspect of the present disclosure, the position restriction member is one of position restriction members located on an one end and another end of the armature holder in the axial direction. The molded resin is in contact with a region extending from one of the position restriction members located on the one end of the armature holder in the axical direction to another of the position restriction members located on the other end of the armature holder in the axial direction. The molded resin is in contact with a component including the pair of intermediate conductor portions of each of the winding segments.

The components including the position restriction members on both axial end sides and the intermediate conductor portions of the winding segments in the axial direction have been subjected to resin-molding. As a result, the molded resin is formed in a region including the entire winding segments, and thus, an unintended decrease in insulation in the winding segments can be appropriately reduced.

According a fourteenth aspect of the present disclosure, the armature includes an armature core provided inward or outward of the armature winding in a radial direction of the armature. The rotary electric machine further comprises an insulating material interposed between the armature core and the pair of intermediate conductor portions of each of the winding segments. The insulating material is a resin material having an adhesive force higher than an adhesive force of a resin material of the insulating layer located on the coil end.

The insulating material interposed between the pair of intermediate conductor portions of each of the winding segments and the armature core is formed of the resin material having an adhesive force higher than an adhesive force of the resin material of the insulating layer provided on the coil end. Thus, strength in attachment of the winding segments to the armature core can be increased, and the positional displacement of the winding segments can be suitably reduced.

According a fifteenth aspect of the present disclosure, the armature includes an armature core provided inward or outward of the armature winding in a radial direction of the armature. The rotary electric machine further comprises an insulating material interposed between the armature core and the pair of intermediate conductor portions of each of the winding segments. The insulating material is a resin material having thermal conductivity higher than thermal conductivity of a resin material of the insulating layer located on the coil end.

The insulating material interposed between the pair of intermediate conductor portions of each of the winding segments and the armature core is formed of the resin material having thermal conductivity higher than thermal conductivity of the resin material of the insulating layer on the coil end. Thus, cooling performance in the intermediate conductor portions can be improved.

According a sixteenth aspect of the present disclosure, a temperature detector detects a temperature of the armature. The molded resin is in contact with the temperature detector, the crossover portion and the position restriction member.

The temperature detector has been integrally subjected to resin-molding along with the crossover portions of the winding segments and the position restriction member. Thus, both heat transfer to the temperature detector and fixing of the temperature detector can be achieved by the resin mold.

According a seventeenth aspect of the present disclosure, the position restriction member is one of a first position restriction member located on a first coil end of the armature holder in the axial direction and a second position restriction member located on a second coil end of the armature holder in the axial direction. The first position restriction member is a separate member from the armature holder and fixed to the armature holder with a fastener. The second position restriction member is integrated with the armature holder and extends outward from the armature holder in a radial direction of the armature.

The first position restriction member, which is a member provided separately from the armature holder, is fixed with the fastener on the first coil end on the axial one end side of the armature holder. The second position restriction member is formed integrally on the second coil end on the axial other end side while extending in the radial direction. According to this configuration, in a case where the winding segments are attached to the armature holder, first, the winding segments can be attached to the armature holder in a state of being positionally restricted by the second position restriction member formed integrally with the armature holder, and thereafter, the first position restriction member can be subsequently attached to an assembly including the armature holder and the winding segments. In this case, since one of the position restriction members is provided on both axial end sides integrally with the armature holder, the movement of the winding segments can be appropriately restricted while the number of components can be reduced and an assembling operation can be simplified.

According a eighteenth aspect of the present disclosure, the winding segments of the armature winding include a first winding segment having a bent crossover portion bent in the radial direction on the second coil end, and a second winding segment having an unbent winding segment including a crossover portion unbent in the radial direction on the second coil end. The second position restriction member includes an annular wall portion having an annular shape and facing a cylindrical portion of the armature holder in the radial direction. The unbent crossover portion is inserted into an annular groove formed between the cylindrical portion and the annular wall portion.

In the second position restriction member extending in the radial direction in the armature holder, the annular wall portion has an annular shape. The unbent crossover portion is inserted into the annular groove formed between the cylindrical portion of the armature holder and the annular wall portion. In this case, by inserting the crossover portion into the annular groove, the radial and axial movement can be restricted, in the winding segments including the crossover portions.

According a nineteenth aspect of the present disclosure, the annular wall portion includes restriction portions arranged at predetermined intervals in the circumferential direction and extending in the axial direction. One of the restriction portions of the second position restriction member is inserted into the second winding segment on an annularly inner side of the bent crossover portion.

The annular wall portion of the second position restriction member is provided with the restriction portions that are provided at predetermined intervals in the circumferential direction while extending in the axial direction. One of the restriction portions is inserted into the second winding segment annularly inward of the bent crossover portion. In this case, the restriction portions of the annular wall portion are placed annularly inward of the crossover portions, whereby the circumferential movement can be restricted, in the winding segments including the crossover portions.

According a twentieth aspect of the present disclosure, the armature includes an armature core provided inward or outward of the armature winding in a radial direction of the armature. The armature core faces the armature holder in the radial direction. the insulating layer includes an insulating material interposed between the armature core and the armature holder.

The insulating material forming the insulating layer is interposed between the armature core and the armature holder, whereby rattling of the armature core with respect to the armature holder can be reduced. In this case, at the time of manufacturing the armature, a gap between the armature core and the armature holder can be used as a passage through which the insulating material (i.e., resin material) flows, whereby formation of the insulating layer (i.e., resin-molding) can be easily performed at each of the coil ends on both axial end sides.

Passages (i.e., resin passages) may be formed between the armature core and the armature holder. The passages may extend in the axial direction while being formed at predetermined intervals in the circumferential direction to allow the insulating material to flow therethrough at the time of manufacturing the armature.

According a twenty-first aspect of the present disclosure, the armature includes an armature core provided inward or outward of the armature winding in a radial direction of the armature. The position restriction member is a separate member from the armature holder. The armature core has a through-hole extending in the axial direction through the armature core. The position restriction member has a through-hole extending in the axial direction through the position restriction member. The position restriction member is placed on an end face of the armature core in the axial direction. The rotary electric machine further comprises a fastener inserted into the through-hole of the armature core and the through-hole of the position restriction member. The fastener has a fastened portion at which the fastener is fastened such that the armature core is located between the position restriction member and the fastened portion.

In the state where the position restriction member is placed on the axial end face of the armature core, the fastener is to be inserted into the respective through-holes of the armature core and the position restriction member, and the fastener is fastened at the fastened portion opposite to the position restriction member with respect to the armature core. As a result, the armature core and the position restriction member can be simultaneously fixed.

Hereinafter, multiple embodiments for implementing the present disclosure will be described referring to drawings. Among the embodiments, parts that correspond to each other may be assigned the same reference numeral, and redundant explanation for the part may be omitted. When only a part of a configuration is described in an embodiment, explanations of the other parts of the configuration described in another preceding embodiment may be used. Parts may be combined among the embodiments even if it is not explicitly described that the parts can be combined. The embodiments may be partially combined even if it is not explicitly described that the embodiments can be combined, provided there is no harm in the combination.

A plurality of embodiments will be described with reference to the drawings. In the plurality of embodiments, functionally and/or structurally corresponding portions and/or functionally and/or structurally associated portions may be denoted by the same reference signs. For the corresponding portions and/or the associated portions, reference can be made to description of other embodiments.

A rotary electric machine in the present embodiments is used as, for example, a vehicle power source. However, the rotary electric machine can be widely used for industrial use, vehicle use, aircraft use, home appliance use, office automation equipment use, game machine use, and the like. In the following embodiments, the same or equivalent portions between the embodiments are denoted by the same reference signs in the drawings, and the description of the portions denoted by the same reference signs is applied between the embodiments.

### First Embodiment

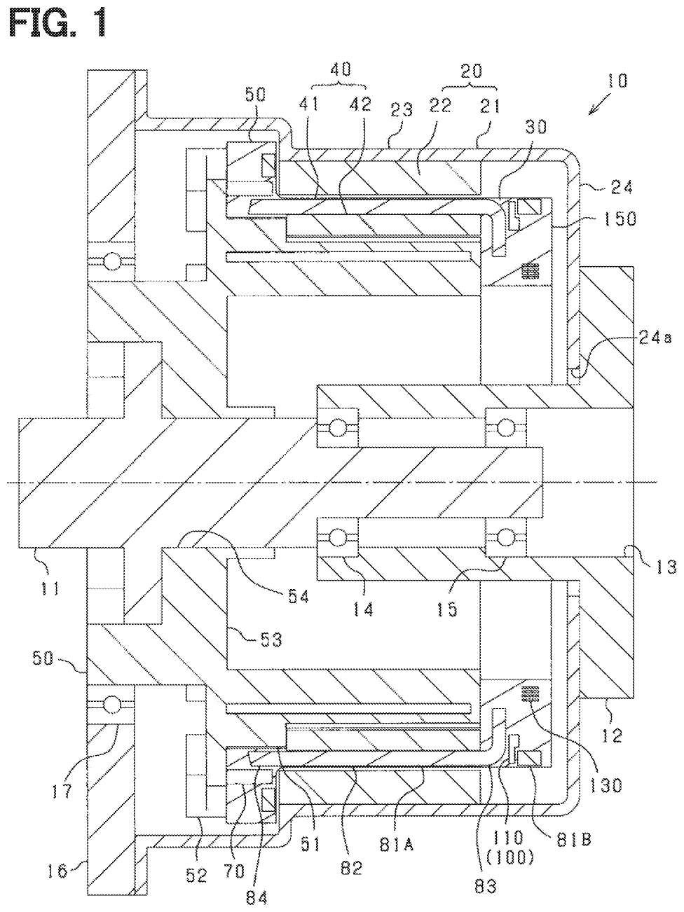

A rotary electric machine 10 according to the present embodiment is a multiphase alternating-current motor of an outer-rotor-type and a surface-magnet-type, and is used as an in-wheel motor of a vehicle. FIG. 1 is a longitudinal cross-sectional view of the rotary electric machine 10. In the following description, in the rotary electric machine 10, a direction in which a rotation axis extends is defined as an axial direction, a direction extending radially from a center of the rotation axis is defined as a radial direction, and a direction extending circumferentially around the rotation axis is defined as a circumferential direction.

The rotary electric machine 10 mainly includes a rotary electric machine main body, and the rotary electric machine main body includes a rotor 20, and a stator unit 30 including a stator 40. The rotary electric machine 10 is configured by integrating a spindle 11 having a substantially columnar shape to be fixed to a vehicle body (not illustrated) and a hub 12 to be fixed to a wheel of a vehicle wheel (not illustrated) with the rotary electric machine main body. The hub 12 includes an insertion hole 13 through which the spindle 11 is inserted. The hub 12 is rotatably supported by a pair of bearings 14, 15 in a state where the spindle 11 is inserted into the insertion hole 13 of the hub 12. In the rotary electric machine 10, the axial direction thereof is the direction in which the axis, serving as a rotation center, extends (a left-right direction in FIG. 1). The rotary electric machine 10 is attached to the vehicle such that the axial direction of the rotary electric machine 10 becomes a horizontal direction or a substantially horizontal direction.

In the rotary electric machine 10, the rotor 20 and the stator 40 are arranged to face each other in the radial direction with an air gap therebetween. The stator unit 30 is fixed to the spindle 11, and the rotor 20 is fixed to the hub 12. Thus, the hub 12 and the rotor 20 are rotatable with respect to the spindle 11 and the stator unit 30. The rotor 20 corresponds to a “field element”, and the stator 40 corresponds to an “armature”.

In a state where an integrated body of the spindle 11 and the stator unit 30 and an integrated body of the hub 12 and the rotor 20 are assembled to each other, a rotor cover 16 is fixed at one (an end around a base end of the spindle 11) of axial ends of the rotor 20. The rotor cover 16 has a circular annular plate shape. The rotor cover 16 is fixed to the rotor 20 with fasteners such as bolts, with a bearing 17 interposed between the rotor cover 16 and the stator unit 30.

The rotor 20 includes a rotor carrier 21 having a substantially cylindrical shape, and a magnet unit 22 having an annular shape and fixed to the rotor carrier 21. The rotor carrier 21 includes a cylindrical-shaped portion 23 having a cylindrical shape, and an end plate portion 24 provided on an axial one end of the cylindrical-shaped portion 23. The magnet unit 22 is fixed annularly on a radially inner face of the cylindrical-shaped portion 23. The axial other end of the rotor carrier 21 is opened. The rotor carrier 21 functions as a magnet holding member. A through-hole 24a is formed in a central portion of the end plate portion 24. In a state where the hub 12 is inserted into the through-hole 24a, the hub 12 is fixed to the end plate portion 24 with fasteners such as bolts.

The magnet unit 22 includes a plurality of permanent magnets arranged such that polarities are alternately changed along the circumferential direction of the rotor 20. With this configuration, the magnet unit 22 has a plurality of magnetic poles in the circumferential direction. The magnet unit 22 corresponds to a “magnet portion”. The permanent magnet is, for example, a sintered neodymium magnet having an intrinsic coercive force of equal to or higher than 400 [kA/m] and a residual magnetic flux density Br of equal to or higher than 1.0 [T].

The magnet unit 22 includes the plurality of permanent magnets, each of which has polar anisotropy. Each of the magnets has easy axes of magnetization whose directions are different between the vicinity of the d-axis (an area closer to the d-axis) and the vicinity of the q-axis (an area closer to the q-axis). In the vicinity of the d-axis, the direction of the easy axis of magnetization approaches a direction parallel to the d-axis, and in the vicinity of the q-axis, the direction of the easy axis of magnetization approaches a direction orthogonal to the q-axis. In this case, a magnet magnetic path is formed in an arc shape along the directions of the easy axes of magnetization. That is, each of the magnets is configured to have orientations with which the direction of the easy axis of magnetization approaches a direction parallel to the d-axis in the vicinity of the d-axis, which is a magnetic pole center, as compared with that in the vicinity of the q-axis, which is a magnetic pole boundary.

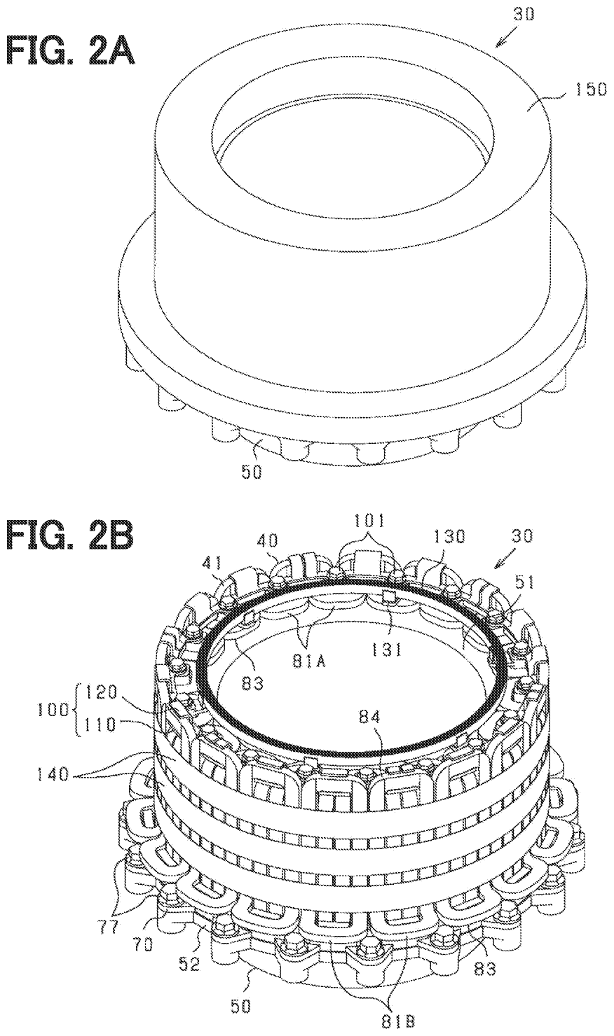

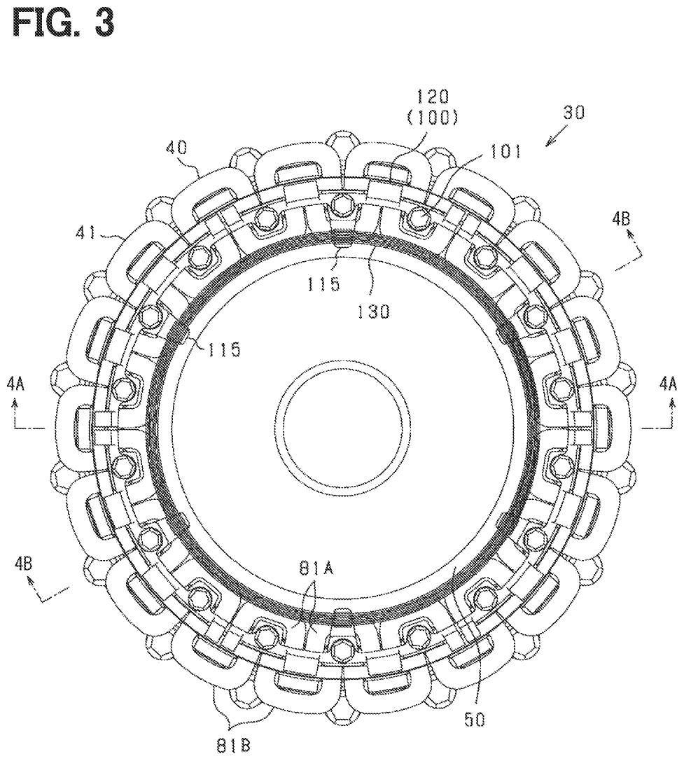

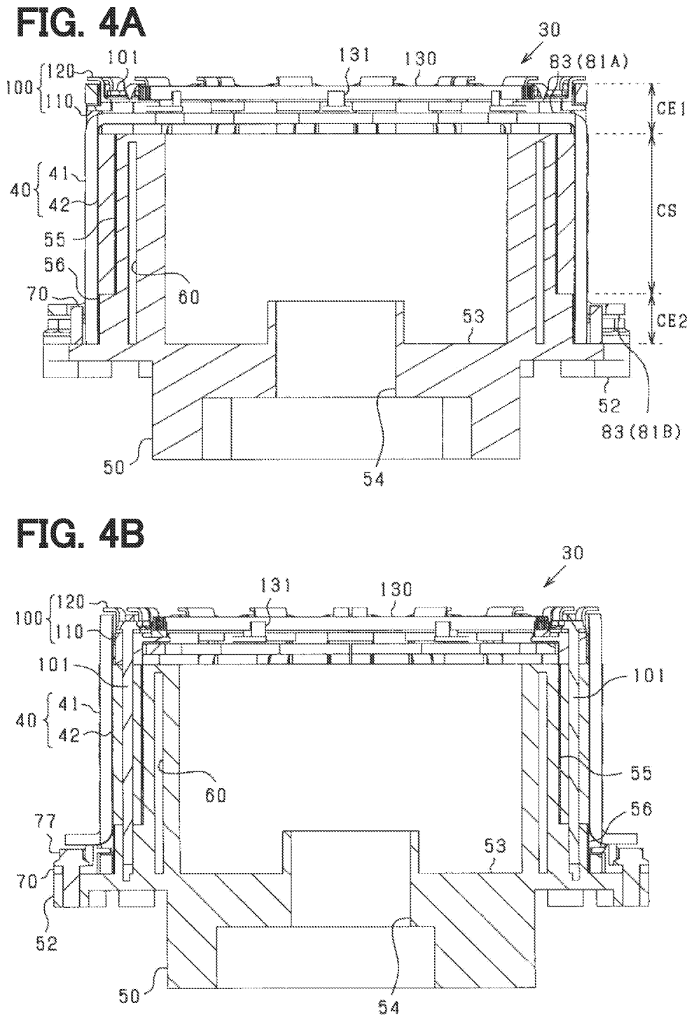

Next, a configuration of the stator unit 30 will be described. FIGS. 2A and 2B are perspective views illustrating appearances of the stator unit 30, and FIG. 2B illustrates a state in which a molded resin provided to the stator unit 30 is removed. FIG. 3 is a top view of the stator unit 30. FIG. 4A is a cross-sectional view taken along line 4A-4A in FIG. 3, and FIG. 4B is a cross-sectional view taken along line 4B-4B in FIG. 3.

The stator unit 30 mainly includes the stator 40, a stator holder 50 provided radially inward of the stator 40, and a wiring module 130. The stator 40 has a toothless structure, and includes a stator winding 41 and a stator core 42. A configuration is made by integrating the stator core 42 and the stator holder 50 to provide these components as a core assembly CA, and by assembling a plurality of winding segments 81 forming the stator winding 41 to the core assembly CA. The stator winding 41 corresponds to an “armature winding”, the stator core 42 corresponds to an “armature core”, and the stator holder 50 corresponds to an “armature holder”. The core assembly CA corresponds to a “support member”.

The stator unit 30 is covered with a resin material in a region including the stator 40 and the wiring module 130. Thus, the stator unit 30 is covered with a molded resin portion 150 except for a part thereof, whereby the stator unit 30 has a form of an appearance in which an outer peripheral face thereof is formed as a resin face (see in FIG. 2A).

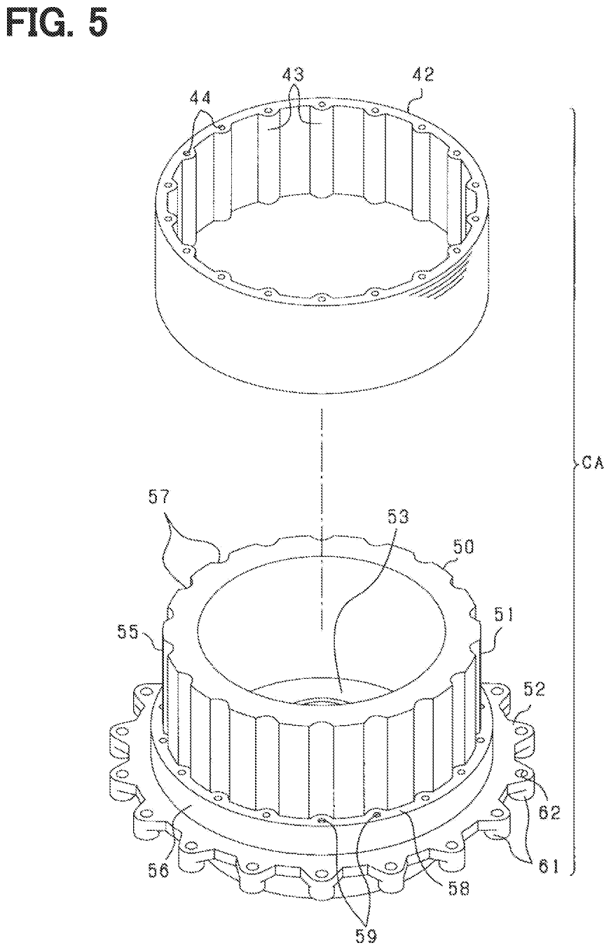

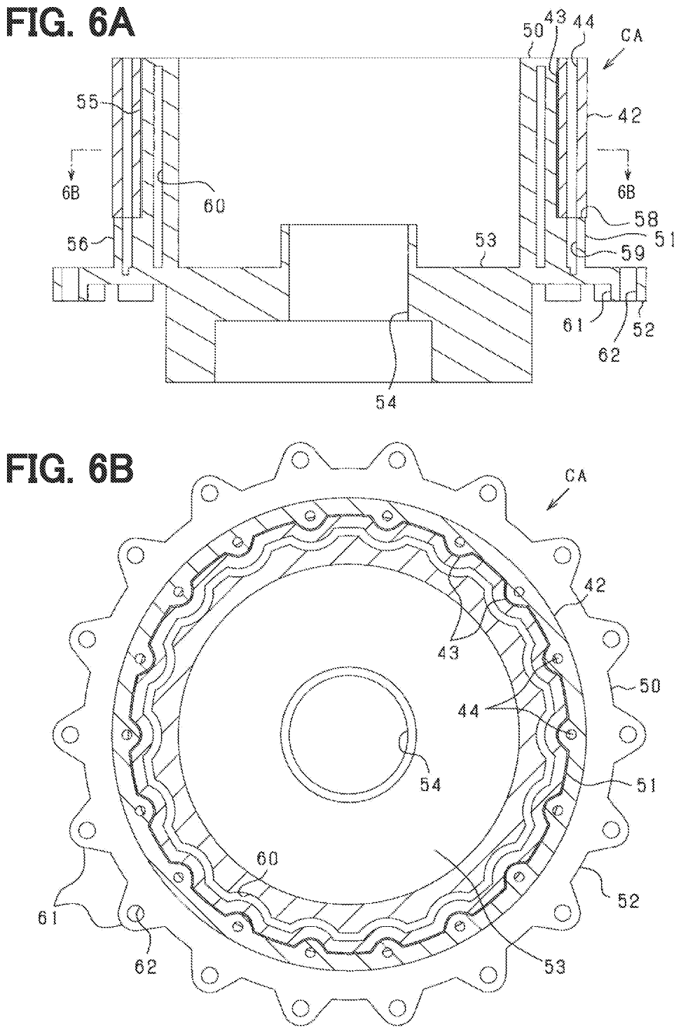

The core assembly CA will be described first. FIG. 5 is a perspective view illustrating the core assembly CA in an exploded state. FIG. 6A is a longitudinal cross-sectional view of the core assembly CA, and FIG. 6B is a transverse cross-sectional view of the core assembly CA (a cross-sectional view taken along line 6B-6B in FIG. 6A).

As described above, the core assembly CA includes the stator core 42, and the stator holder 50 assembled radially inward of the stator core 42. That is, the core assembly CA is configured by assembling the stator core 42 integrally to the outer peripheral face of the stator holder 50.

The stator core 42 is formed as a core-sheet laminate body in which core sheets each formed of an electromagnetic steel sheet that is a magnetic body are laminated in the axial direction. The stator core 42 has a cylindrical shape having a predetermined thickness in the radial direction. The outer peripheral face of the stator core 42, facing radially outward, has a curved face shape without unevenness, and the stator winding 41 is assembled to the outer peripheral face of the stator core 42 (that is, the face facing the rotor 20 in the radial direction). The stator core 42 functions as a back yoke. The stator core 42 is formed by, for example, axially laminating the plurality of core sheets each punched into a circular annular plate shape. However, the stator core 42 may be a stator core having a helical core structure. In the stator core 42 having a helical core structure, a stator core 42 having a cylindrical shape as a whole is formed by using a core sheet having a strip shape, and by annularly winding and axially laminating the core sheet.

In the stator core 42, a plurality of raised portions 43 is provided, on the inner peripheral face thereof facing radially inward, at predetermined intervals in the circumferential direction. Each of the raised portions 43 is a portion that locally increases the thickness in the radial direction of the stator core 42. In the portions thickened by the raised portions 43, respective through-holes 44 extending therethrough in the axial direction are formed.

In the present embodiment, the stator 40 has a slotless structure including no tooth for forming a slot, and the configuration thereof may use any of the following configurations (A) to (C). Each of the configurations (A) to (C) substantially corresponds to a toothless structure.
(A) In the stator 40, an inter-conductor member is provided between conductor portions (intermediate conductor portions 82 to be described later) in the circumferential direction. Simultaneously, a magnetic material having a relationship of Wt×Bs≤Wm×Br is used as the inter-conductor member, in a case where a width dimension in the circumferential direction of the inter-conductor member in a single magnetic pole is Wt, a saturation magnetic flux density of the inter-conductor member is Bs, a width dimension in the circumferential direction of a magnet in a single magnetic pole is Wm, and a residual magnetic flux density of the magnet is Br.
(B) In the stator 40, an inter-conductor member is provided between conductor portions (intermediate conductor portions 82) in the circumferential direction, and a non-magnetic material is used as the inter-conductor member.
(C) In the stator 40, no inter-conductor member is provided between conductor portions (intermediate conductor portions 82) in the circumferential direction.

The stator holder 50 includes a cylindrical portion 51 to which the stator core 42 is assembled, an outwardly-extending portion 52 extending radially outward with respect to the cylindrical portion 51, and a bottom portion 53 formed radially inward of the cylindrical portion 51. In the bottom portion 53, a through-hole 54 extending therethrough in the axial direction is provided, and the spindle 11 can be inserted into the through-hole 54. The stator holder 50 is formed of, for example, metal such as aluminum or cast iron, or a carbon fiber reinforced plastic (CFRP).

The cylindrical portion 51 has a two-stepped outer peripheral face, and includes a small-diameter portion 55 and a large-diameter portion 56. The stator core 42 is assembled to the small-diameter portion 55. The small-diameter portion 55 is provided with a plurality of recessed portions 57 corresponding to the raised portions 43 of the stator core 42. When the stator core 42 is assembled to the stator holder 50, the raised portions 43 of the stator core 42 are fitted onto the recessed portions 57 of the stator holder 50.

In the large-diameter portion 56, an end face 58 is formed toward the small-diameter portion 55, and a plurality of holes 59 extending in the axial direction is formed in a state of being opened to the end face 58. In the holes 59, respective internal threads are formed. In a state where the stator core 42 is assembled to the stator holder 50, the through-holes 44 in the stator core 42 and the holes 59 in the stator holder 50 communicate with each other in the axial direction. The outer diameter of the stator core 42 matches the outer diameter of the large-diameter portion 56 of the stator holder 50.

In the cylindrical portion 51, a cooling medium passage 60 through which a cooling medium such as cooling water flows is formed. The cooling medium passage 60 extends in the axial direction, and is provided annularly along the cylindrical portion 51. The cooling medium passage 60 allows the cooling medium to flow in the circumferential direction between an inlet portion and an outlet portion (not illustrated). In the present embodiment, the plurality of recessed portions 57 is provided in the small-diameter portion 55 as described above, and thus the cooling medium passage 60 is formed such that the cooling medium passage 60 is recessed radially inward for each of the recessed portions 57. However, the cooling medium passage 60 need not be recessed for each of the recessed portions 57, and may be formed in a completely annular shape in which no recess is formed.

The cylindrical portion 51 preferably has a double structure including a radially outer cylindrical member and a radially inner cylindrical member to form the cooling medium passage 60 by using a gap space between the outer cylindrical member and the inner cylindrical member. Although not illustrated, an external circulation path for circulating the cooling medium is connected to the cooling medium passage 60. The external circulation path is provided with, for example, an electric pump, and a heat dissipation device such as a radiator. With the driving of the pump, the cooling medium circulates through the circulation path and the cooling medium passage 60 of the rotary electric machine 10.

The outwardly-extending portion 52 is provided with a plurality of protruding portions 61 at predetermined intervals in the circumferential direction. In the protruding portions 61, respective through-holes 62 extending therethrough in the axial direction are formed. In the through-holes 62, respective internal threads are formed. The number of provided raised portions 43 (the number of provided through-holes 44) of the stator core 42 and the number of provided protruding portions 61 are the same, and the number is, for example, 18 in the present embodiment.

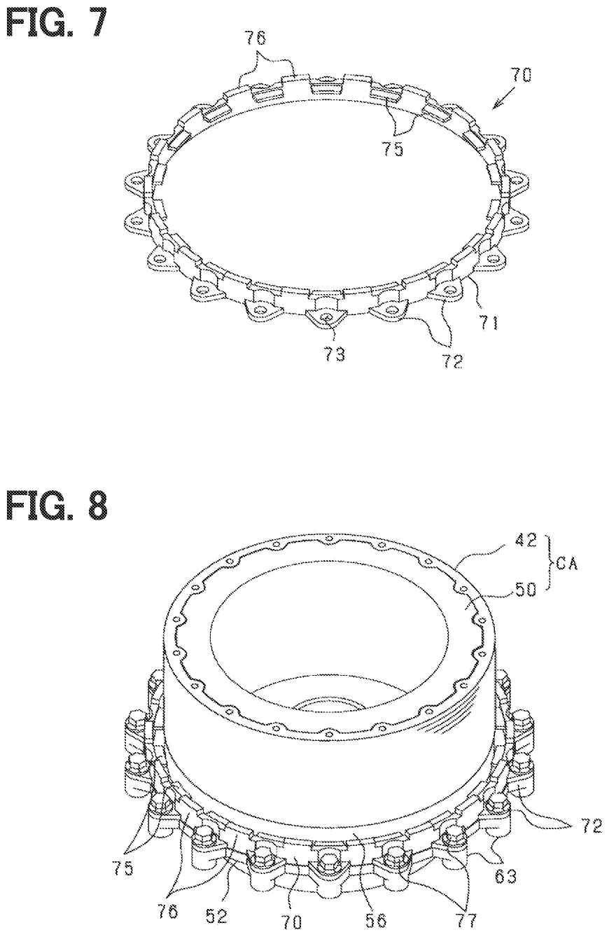

A position restriction member 70 that restricts the positions of the winding segments 81 assembled to the core assembly CA is configured to be fixed to the outwardly-extending portion 52 of the stator holder 50 (see (b) in FIG. 2). FIG. 7 is a perspective view of the position restriction member 70, and FIG. 8 is a perspective view illustrating a state in which the position restriction member 70 is assembled to the core assembly CA.

The position restriction member 70 includes a circular annular portion 71 having a diameter larger than the diameter of the large-diameter portion 56 of the stator holder 50. A plurality of protruding portions 72 protruding radially outward is provided on the circular annular portion 71. The protruding portions 72 are provided at predetermined intervals in the circumferential direction. The positions of the protruding portions 72 match the positions of the protruding portions 61 provided in the outwardly-extending portion 52 of the stator holder 50. In the protruding portions 72, respective through-holes 73 extending therethrough in the axial direction are formed.

Restriction portions 75, 76 that restrict positions of crossover portions (crossover portions 83, 84 to be described later) of the winding segments 81 assembled to the core assembly CA are provided on the circular annular portion 71. The restriction portions 75 are provided at predetermined intervals in the circumferential direction to extend radially inward from the circular annular portion 71. The restriction portions 76 are provided at predetermined intervals in the circumferential direction to extend axially from the circular annular portion 71. The restriction portions 75, 76 are projecting portions extending in the circumferential direction, and are provided to be arranged alternately in the circumferential direction.

The position restriction member 70 is a member that has a function of restricting the positions of the winding segments 81, and is desirably a member having high rigidity. In the present embodiment, the position restriction member 70 is formed of metal. Specifically, the position restriction member 70 in the present embodiment is formed of, for example, aluminum, an aluminum alloy, cast iron, or the like.

In FIG. 8, the position restriction member 70 is assembled to the outwardly-extending portion 52 of the stator holder 50. That is, bolts 77 serving as fasteners are screwed into the protruding portions 61 in the outwardly-extending portion 52 and the protruding portions 72 in the position restriction member 70, whereby the position restriction member 70 is fixed to the core assembly CA. In this state, the large-diameter portion 56 of the stator holder 50 and the position restriction member 70 face each other in the radial direction to form an annular space therebetween. The positions of the winding segments 81 are restricted by the annular space and the restriction portions 75, 76 of the position restriction member 70. However, details thereof will be described later.

An annular inner space is formed inward of the inner periphery of the cylindrical portion 51, and a configuration may be made in which, for example, an electric component forming an inverter serving as an electric power converter is disposed in the inner space. The electric component is, for example, an electric module in which a semiconductor switching element or a capacitor is packaged. By disposing the electric module in contact with the inner peripheral face of the cylindrical portion 51, the electric module can be cooled by the cooling medium flowing through the cooling medium passage 60.

Next, the configuration of the stator winding 41 assembled to the core assembly CA will be described in detail. A state in which the stator winding 41 is assembled to the core assembly CA is as illustrated in FIGS. 2 to 14. The plurality of winding segments 81 forming the stator winding 41 is assembled, in a state of being arranged in the circumferential direction, radially outward of the core assembly CA, that is, radially outward of the stator core 42. The stator winding 41 includes a plurality of phase windings, and is formed in a cylindrical shape (annular shape) by arranging the plural-phase windings in a predetermined order in the circumferential direction. In the present embodiment, the stator winding 41 includes three phase windings by using the U-phase, V-phase, and W-phase windings.

As illustrated in FIG. 4A, the stator 40 includes, in the axial direction, portions corresponding to a coil side CS radially facing the stator core 42, and portions corresponding to coil ends CE1, CE2 located at axially outer positions with respect to the coil side CS. The coil side CS is also a portion facing the magnet unit 22 of the rotor 20 in the radial direction. In this case, the winding segments 81 are assembled in a state where both axial end portions thereof protrude outward in the axial direction (that is, toward the coil ends CE1, CE2) with respect to the stator core 42. The winding segments 81 are provided in accordance with the number of poles of the rotary electric machine 10, and a plurality of winding segments 81 are connected in parallel or in series for each phase. In the present embodiment, the number of magnetic poles is 24, but the number of magnetic poles may be set to an appropriate number.

Each of the winding segments 81 is provided such that a first one of both axial ends is bent in the radial direction and a second one of both axial ends is unbent in the radial direction. Half of the winding segments 81 out of all the winding segments 81 each are configured such that a portion in an axial one end range is formed as a bent portion and this bent portion is bent radially inward. The remaining half of the winding segments 81 each are configured such that a portion in the axial other end range is formed as a bent portion and this bent portion is bent radially outward. In the following description, among the winding segments 81, the winding segment 81 including the bent portion bent radially inward is also referred to as a “winding segment 81A”, and the winding segment 81 including the bent portion bent radially outward is also referred to as a “winding segment 81B”.

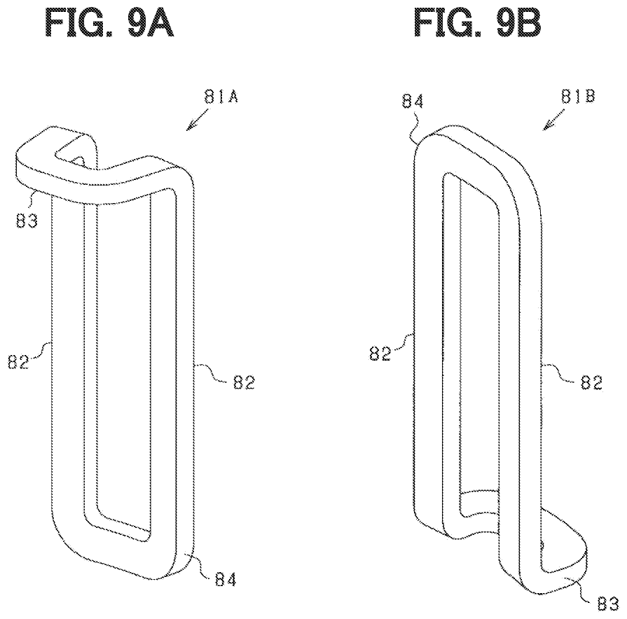

The configurations of the winding segments 81A, 81B will be described in detail. FIGS. 9A and 9B are perspective views illustrating respective configurations of the winding segments 81A, 81B.

Each of the winding segments 81A, 81B is formed by winding a conductor material a plurality of times, and includes a pair of intermediate conductor portions 82 and a pair of crossover portions 83, 84. The pair of intermediate conductor portions 82 are provided in parallel to each other, and have a linear shape. The pair of crossover portions 83, 84 connect the pair of intermediate conductor portions 82 at both axial ends. Each of the winding segments 81A, 81B is formed in an annular shape by the pair of intermediate conductor portions 82 and the pair of crossover portions 83, 84. The pair of intermediate conductor portions 82 are provided to be separated from each other by a distance of a predetermined coil pitch. Thus, between the pair of intermediate conductor portions 82, an intermediate conductor portion 82 of a winding segment 81 of another phase can be arranged, in the circumferential direction. In the present embodiment, the pair of intermediate conductor portions 82 are provided to be separated from each other by a distance of two coil pitches. Thus, between the pair of intermediate conductor portions 82, intermediate conductor portions 82 of winding segments 81 of the other two phases are configured to be arranged one by one. In a state where the winding segments 81A, 81B are arranged in the circumferential direction, respective intermediate conductor portions 82 of winding segments 81A, 81B different from each other are arranged in the circumferential direction in a state close to each other.

Regarding the crossover portions 83, 84 in both axial end ranges, the crossover portion 83 is provided as a portion corresponding to the coil end CE1 or the coil end CE2 and the crossover portion 84 is provided as a portion corresponding to the coil end CE1 or the coil end CE2 (see in FIG. 4A). Of the crossover portions 83, 84, the crossover portion 83 is formed to be bent in the radial direction, and the crossover portion 84 opposite to the crossover portion 83 is formed without being bent in the radial direction. The crossover portion 83 is a “bent crossover portion”, and the crossover portion 84 is an “unbent crossover portion”. The crossover portion 83 is provided to be bent in a direction orthogonal to a direction in which the intermediate conductor portion 82 extends, that is, in a direction orthogonal to the axial direction. Thus, each of the winding segments 81A, 81B has a substantially L-shape when laterally viewed.

In the winding segments 81A, 81B, bent directions of the respective crossover portions 83 in the radial direction are different. That is, in the winding segment 81A, the crossover portion 83 is bent inward in the radial direction. In the winding segment 81B, the crossover portion 83 is bent outward in the radial direction. When an arrangement of the winding segments 81A, 81B in the circumferential direction in this case is assumed, respective shapes in plan view (planar shapes in the radial direction) of the crossover portions 83 in the winding segments 81A, 81B are preferably different from each other. In the crossover portion 83 of the winding segment 81A, a width thereof in the circumferential direction is preferably narrowed toward a tip end. In the crossover portion 83 of the winding segment 81B, a width thereof in the circumferential direction is preferably widen toward a tip end.

In FIG. 4A, the crossover portion 83 of the winding segment 81A is bent radially inward in the range of the coil end CE1 (upper in the drawing) that is the one end range of both axial end ranges, and the crossover portion 83 of the winding segment 81B is bent radially outward in the range of the coil end CE2 (lower in the drawing) that is the other end range.

In the winding segments 81A, 81B, the intermediate conductor portions 82 are provided as coil side conductor portions arranged one by one in the circumferential direction, in the coil side CS. The crossover portions 83, 84 are provided as coil end conductor portions connecting the same phase intermediate conductor portions 82 at two different positions in the circumferential direction, in the coil ends CE1, CE2.

The winding segments 81A, 81B are formed by winding a conductor material a plurality of times such that the cross section of a conductor bundled portion has a quadrangular shape. In the intermediate conductor portion 82, the conductor material is arranged to form a plurality of columns in the circumferential direction and a plurality of columns in the radial direction, whereby the intermediate conductor portion 82 is formed to have a transverse cross section with a substantially rectangular shape.

In a state where the conductor material is wound a plurality of times, each of the winding segments 81A, 81B is preferably covered with an insulating material. Although detailed description with illustration in the drawings is omitted, in the winding segments 81A, 81B, each of the intermediate conductor portions 82 is preferably covered with an insulating covering body having a sheet shape. For example, a configuration is conceivable in which an insulating film material is wound around the intermediate conductor portion 82. For each of the crossover portions 83, 84, an insulating cover formed in accordance with the shape of the crossover portion is preferably attached thereto. The insulating cover can insulate the crossover portions of the winding segments 81A, 81B from each other. Each of the winding segments 81A, 81B may be configured to be entirely covered with a resin material by resin immersion or the like.

As described above, in the state where the winding segments 81 are assembled to the core assembly CA, the positions of the winding segments 81 are restricted by the position restriction member 70 in the range of the coil end CE2 (lower in FIG. 4A). In the range of the coil end CE1 (upper in FIG. 4A), the positions of the winding segments 81 are restricted by a position restriction member 100, which is a member different from the position restriction member 70. That is, the position of each of the winding segments 81 is restricted by the position restriction member 70 at the end where the crossover portion 83 is bent radially outward (the range of CE2) of both axial ends, whereas the position of each of the winding segments 81 is restricted by the position restriction member 100 at the end where the crossover portion 83 is bent radially inward (the range of CE1).

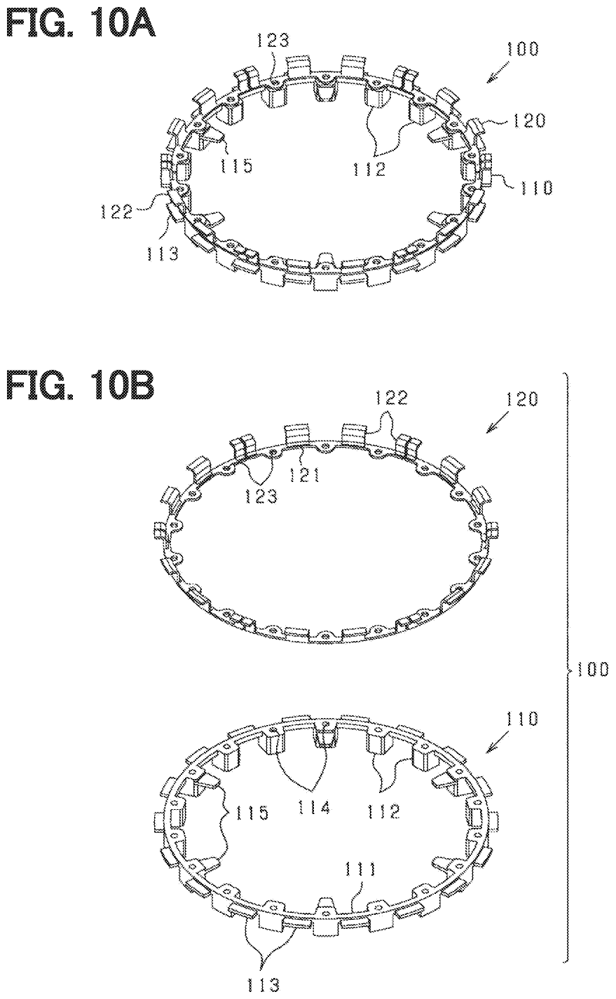

Hereinafter, the configuration of the position restriction member 100 will be described. FIG. 10A is a perspective view of the position restriction member 100, and FIG. 10B is a perspective view illustrating a state in which a first annular member 110 and a second annular member 120 forming the position restriction member 100 are separated from each other. The position restriction member 100 includes the first annular member 110 and the second annular member 120, which are formed in respective annular shapes and provided in an axially overlapping state. The first annular member 110 is provided in a state of being in contact with an axial end face of the stator core 42. The second annular member 120 is provided at a position opposite to the stator core 42 across the first annular member 110, in the axial direction. In the range of the coil end CE1, the positions of the winding segments 81 are restricted by the position restriction member 100 including the first annular member 110 and the second annular member 120, which are separable from each other.

Like the position restriction member 70, each of the annular members 110, 120 is a member that has a function of restricting the positions of the winding segments 81, and is desirably a member having high rigidity. In the present embodiment, each of the annular members 110, 120 is formed of metal. Specifically, each of the annular members 110, 120 in the present embodiment is formed of, for example, aluminum, an aluminum alloy, cast iron, or the like.

As illustrated in (b) in FIG. 10, the first annular member 110 includes a circular annular portion 111, and restriction portions 112, 113 provided on the circular annular portion 111 at respective predetermined intervals. The restriction portions 112 are provided to extend axially from the circular annular portion 111, whereas the restriction portions 113 are provided to extend radially outward from the circular annular portion 111. These restriction portions 112, 113 are provided to be arranged alternately in the circumferential direction. In the restriction portions 112, respective through-holes 114 extending therethrough in the axial direction are formed. Among the plurality of restriction portions 112 arranged in the circumferential direction, some restriction portions 112 are provided with protruding portions 115 protruding radially inward.

The second annular member 120 includes a circular annular portion 121, and restriction portions 122 provided on the circular annular portion 121 at predetermined intervals. The restriction portions 122 are provided to extend axially from the circular annular portion 121, and are further bent radially outward in respective tip end ranges of the restriction portions 122. In the circular annular portion 121, through-holes 123 extending therethrough in the axial direction are formed.

As illustrated in FIG. 10A, in a state where the first annular member 110 and the second annular member 120 are integrated, the respective circular annular portions 111, 121 of the annular members 110, 120 overlap with each other, whereby the respective through-holes 114, 123 of the annular members 110, 120 are brought into a state where the through-holes 114 communicate with the through-holes 123 in the axial direction. The restriction portions 113 of the first annular member 110 face the restriction portions 122 of the second annular member 120 in a state where the restriction portions 113 are separated from the restriction portions 122 in the axial direction (upper-lower direction in the drawing).

To reduce mutual positional displacement in a state where the annular members 110, 120 overlap with each other, at least one of the annular members 110, 120 is preferably provided with an engagement portion enabling, for example, projection-recess engagement. As a result, the positional displacement is reduced in the annular members 110, 120 at the time of assembling the annular members 110, 120 to the core assembly CA.

The position restriction member 100 (the first annular member 110 and the second annular member 120) is configured to be fixed to the core assembly CA with long bolts 101. Specifically, as illustrated in each of in FIGS. 4A and 4B, the position restriction member 100 is assembled to the axial end face of the stator core 42. In the assembled state, the respective through-holes 114, 123 of the annular members 110, 120, the through-holes 44 of the stator core 42, and the holes 59 of the stator holder 50 communicate with one another in the axial direction. By screwing the long bolts 101 into the series of holes, the position restriction member 100 is fixed to the core assembly CA.

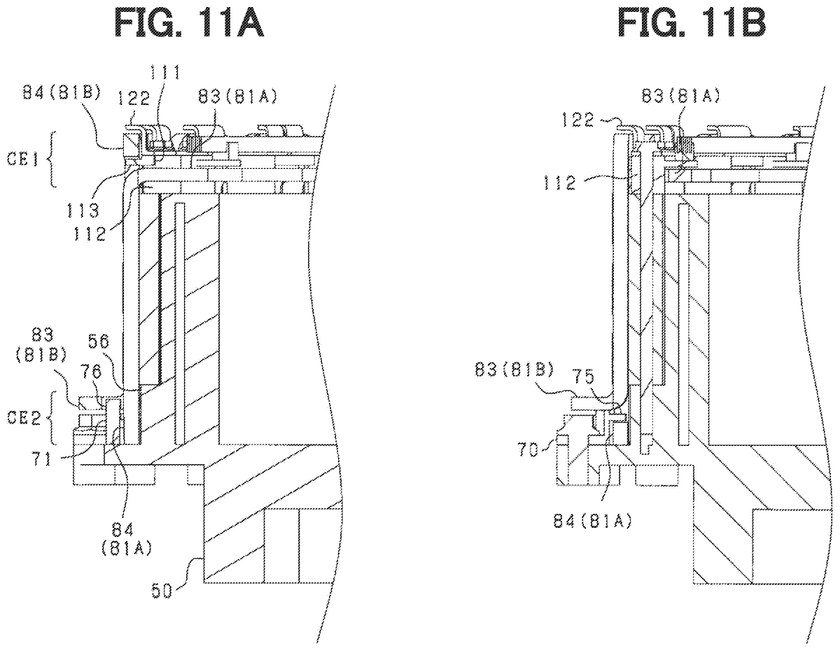

The outline of the position restriction for the winding segments 81A, 81B made by the position restriction members 70, 100 will be described with reference to FIG. 11. FIGS. 11A and 11B are enlarged views illustrating parts in FIGS. 4A and 4B, and FIG. 11A corresponds to FIG. 4A and FIG. 11B corresponds to FIG. 4B.

As illustrated in each of FIGS. 11A and 11B, in the range of the coil end CE2, the circular annular portion 71 of the position restriction member 70 and the large-diameter portion 56 of the stator holder 50 face each other in the radial direction to form the annular space therebetween. The crossover portions 84 (unbent crossover portions) of the winding segments 81A are inserted into the annular space. As a result, the radial and axial positions of the winding segments 81A are restricted in the range of the coil end CE2. Each of the restriction portions 75 of the position restriction member 70 is placed at a position annularly inward with respect to a corresponding one of the crossover portions 84 of the winding segments 81A, whereby the circumferential and axial positions of the winding segments 81A are restricted in the range of the coil end CE2.

Each of the restriction portions 76 of the position restriction member 70 is placed at a position annularly inward with respect to a corresponding one of the crossover portions 83 (bent crossover portions) of the winding segments 81B, whereby the circumferential positions of the winding segments 81B are restricted in the range of the coil end CE2.

On the other hand, in the range of the coil end CE1, the axial positions of the winding segments 81A are restricted by the circular annular portion 111 of the first annular member 110. Each of the restriction portions 112 of the first annular member 110 is placed at a position annularly inward with respect to a corresponding one of the crossover portions 83 of the winding segments 81A, whereby the circumferential and radial positions of the winding segments 81A are restricted in the range of the coil end CE1.

Each of the crossover portions 84 of the winding segments 81B is arranged between a corresponding one of the restriction portions 113 of the first annular member 110 and a corresponding one of the restriction portions 122 of the second annular member 120, whereby the circumferential and axial positions of the winding segments 81B are restricted in the range of the coil end CE1. Each of the position restriction members 70, 100 is provided as a common member that commonly restricts both the positions of the winding segments 81A, 81B.

Next, the wiring module 130 will be described. The wiring module 130 is a winding connection member electrically connected to the winding segments 81A, 81B, in the stator winding 41. By the wiring module 130, the plural-phase winding segments 81 are connected in parallel or in series for each phase, and the plural-phase windings are connected at a neutral point. As illustrated in each of FIGS. 4A and 4B, the wiring module 130 is provided in the range of the coil end CE1, that is, in the one end range of both axial end ranges where the crossover portions 83 of the winding segments 81A are bent radially inward.

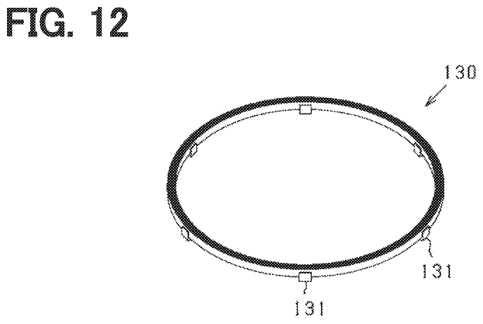

As illustrated in FIG. 12, the wiring module 130 is formed in a circular annular shape, and a plurality of pedestal portions 131 is provided at predetermined intervals in the circumferential direction. The wiring module 130 is fixed to the position restriction member 100. Specifically, the pedestal portions 131 are fixed to the protruding portions 115 (see FIG. 10A) provided in the first annular member 110, whereby the wiring module 130 is fixed to the position restriction member 100. In the range of the coil end CE1, the crossover portions 84 of the winding segments 81B are annularly arranged, and the wiring module 130 is provided radially inward of the crossover portions 84 of the winding segments 81B.

Although a detailed configuration is omitted, the wiring module 130 includes, for respective phases, wiring members such as bus bars, and each of the wiring members is connected to a corresponding phase one of electric power input and output lines. Then, the plural-phase electric power input and output lines are connected to an inverter (not illustrated) to allow electric power to be input and output. A current sensor that detects the phase current of each phase may be integrally provided in the wiring module 130. The wiring module 130 is simply required to be formed in an annular shape in accordance with the form of the stator winding 41. Thus, the wiring module 130 may have a polygonal annular shape, or a substantially C-shape in which a part of the annular shape is missing.

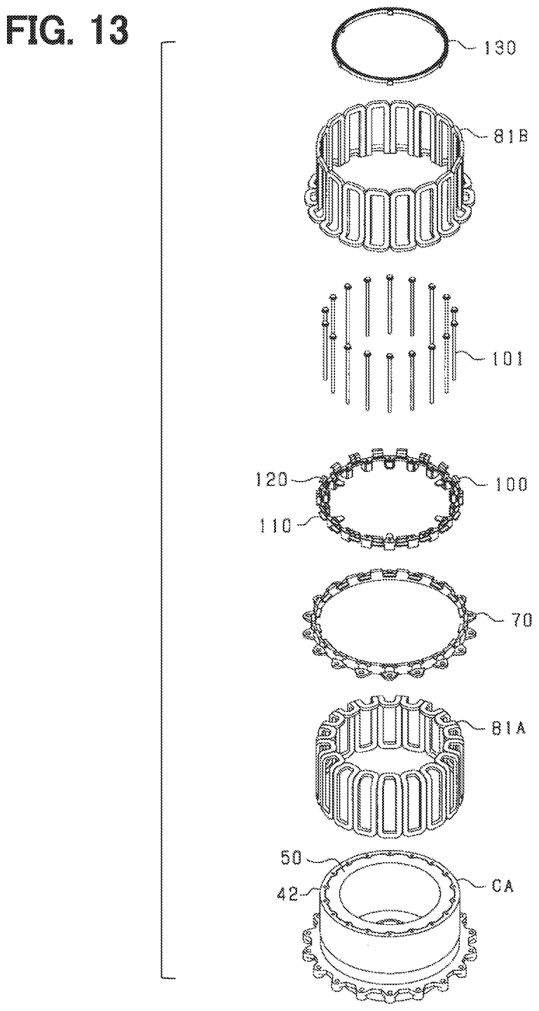

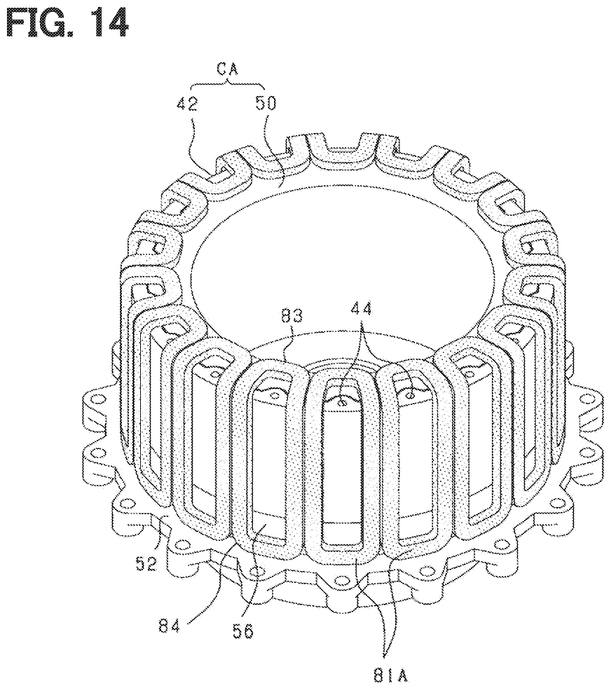

Next, an assembling procedure of the members in the stator unit 30 and specific configurations of the details of the stator unit 30 will be described. FIG. 13 is an exploded perspective view of the stator unit 30 disassembled in an assembling order. In FIG. 13, the stator unit 30 is illustrated in an exploded state of being disassembled into the core assembly CA, the winding segments 81A, the position restriction members 70, 100, the winding segments 81B, and the wiring module 130. FIGS. 14 to 17 are perspective views illustrating configurations in the assembling processes of the stator unit 30.

In the assembling of the stator unit 30, first, the plurality of winding segments 81A is assembled to the core assembly CA, in FIG. 14. In this state, in the range of the coil end CE1 (upper in the drawing), the crossover portions 83 (bent crossover portions) of the winding segments 81A are arranged to face the axial end face of the stator core 42. In this case, each of the winding segments 81A is arranged while a corresponding one of the through-holes 44 of the stator core 42 is set as a circumferential center position of the arrangement. In the range of the coil end CE2 (lower in the drawing), the crossover portions 84 (unbent crossover portions) of the winding segments 81A are in a state of facing an axial end face of the outwardly-extending portion 52 of the stator holder 50 and being arranged in the circumferential direction along the large-diameter portion 56.

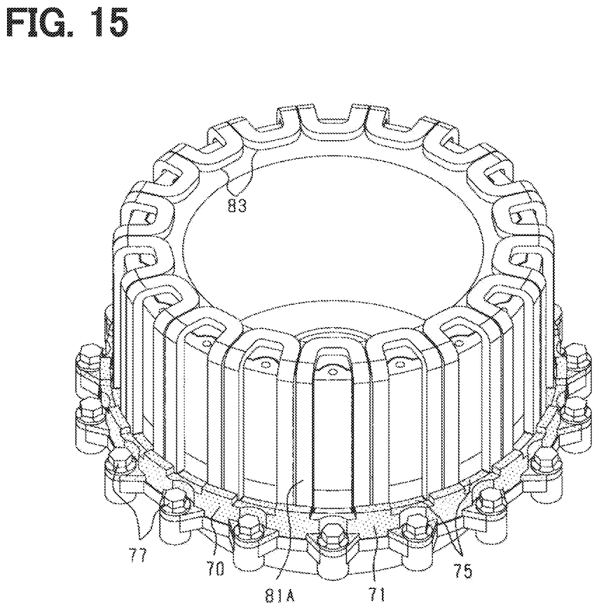

In FIG. 15, the position restriction member 70 in the range of the coil end CE2 is assembled to the assembly in the state of FIG. 14. At this time, the position restriction member 70 is assembled from above in the axial direction, and the position restriction member 70 is fixed to the core assembly CA by screwing the bolts 77. In this state, the crossover portions 84 of the winding segments 81A are in a state of being placed between the circular annular portion 71 of the position restriction member 70 and the large-diameter portion 56 of the stator holder 50, and the radial positions of the winding segments 81A are restricted in the range of the coil end CE2. Each of the restriction portions 75 of the position restriction member 70 is placed between a corresponding one pair of the pairs of intermediate conductor portions 82 of the winding segments 81A to axially face a tip end portion of a corresponding one of the crossover portions 84 of the winding segments 81A, whereby the circumferential and axial positions of the winding segments 81A are restricted in the range of the coil end CE2.

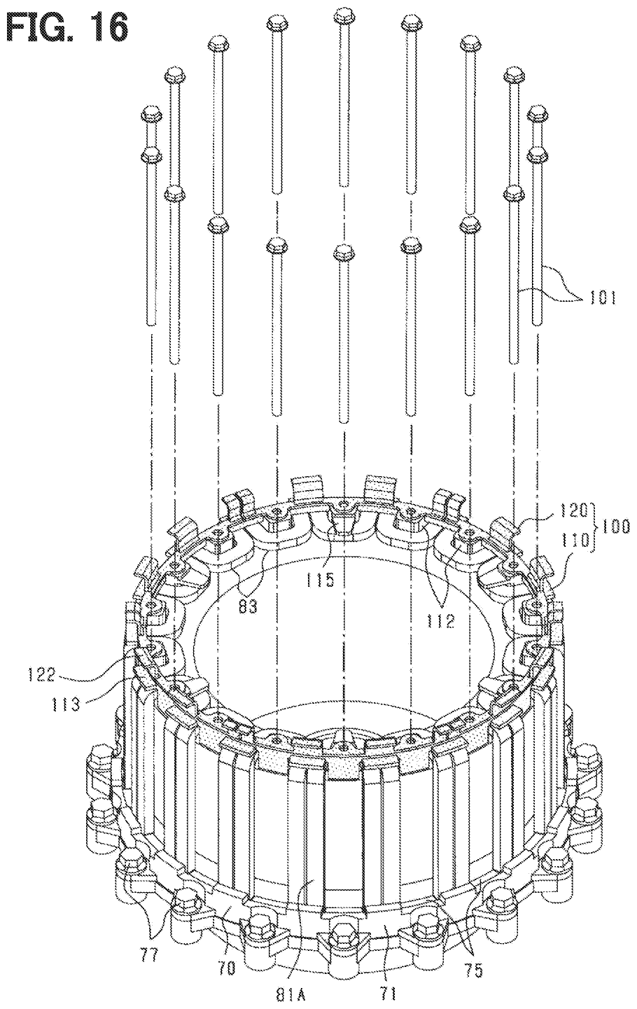

In FIG. 16, the position restriction member 100 in the range of the coil end CE1 is assembled to the assembly in the state of FIG. 15. The annular members 110, 120 of the position restriction member 100 are assembled from an axially outer position with respect to the crossover portions 83 of the winding segments 81A, and are fixed to the core assembly CA by screwing the long bolts 101. In this state, the axial positions of the winding segments 81A are restricted by the circular annular portion 111 of the first annular member 110. Each of the restriction portions 112 of the first annular member 110 is placed at a position annularly inward with respect to a corresponding one of the crossover portions 83 of the winding segments 81A, whereby the circumferential and radial positions of the winding segments 81A are restricted in the range of the coil end CE1.

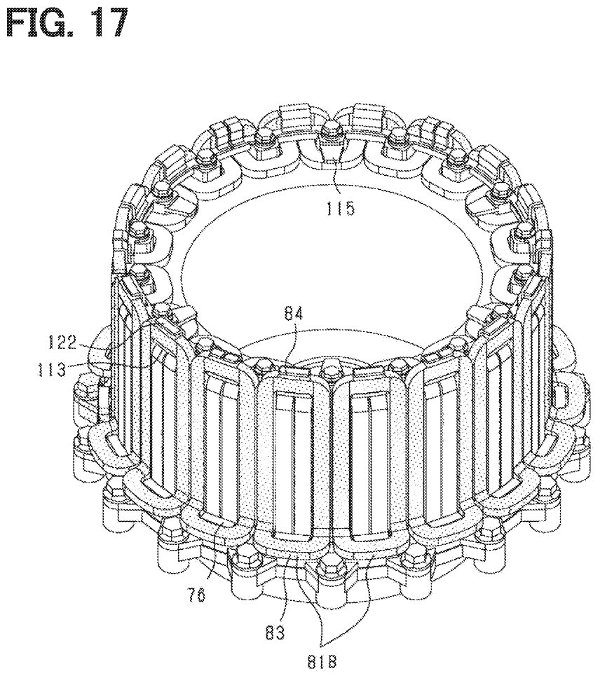

In FIG. 17, the plurality of winding segments 81B is assembled to the assembly in the state of FIG. 16. At this time, the winding segments 81B are assembled from radially outside such that each of the intermediate conductor portions 82 of the winding segments 81B is placed between corresponding ones of the intermediate conductor portions 82 of the winding segments 81A. In this state, each of the restriction portions 76 of the position restriction member 70 is placed at a position annularly inward with respect to a corresponding one of the crossover portions 83 of the winding segments 81B, whereby the circumferential positions of the winding segments 81B are restricted in the range of the coil end CE2. Each of the crossover portions 84 of the winding segments 81B is arranged between a corresponding one of the restriction portions 113 of the first annular member 110 and a corresponding one of the restriction portions 122 of the second annular member 120, whereby the circumferential and axial positions of the winding segments 81B are restricted in the range of the coil end CE1.

Then, the wiring module 130 is assembled to the assembly in the state of FIG. 17 (see FIG. 4B).

As illustrated in FIG. 2B, coil covers 140 each having a sheet shape (band shape) are attached radially outward of the winding segments 81A, 81B as restraint members that restrain the winding segments 81A, 81B. Each of the coil covers 140 is an endless cover formed in a circular annular shape, and is provided to cover the winding segments 81A, 81B from a radially outer position with respect to the winding segments 81A, 81B. The coil covers 140 are provided in a range including at least the coil side CS in the axial direction, and are provided in a plurally divided manner in the axial direction, as illustrated in the drawing. However, the coil cover 140 may be provided as a single cover. The coil cover 140 is preferably a sheet material having an insulation property and capable of being flexibly deformed. The sheet material is, for example, an insulating resin sheet. The coil cover 140 may have a spring shape and a tightening force.

The coil cover 140 may be configured using an insulating material such as synthetic resin, or may be configured such that a conductive material is covered with an insulating material such as synthetic resin. That is, in the coil cover 140, at least an outer surface thereof preferably has an insulation property. As the restraint member, a member having a string shape may be wound radially outward of the winding segments 81A, 81B.

As illustrated in FIG. 2A, in the stator unit 30 of the present embodiment, resin-molding is performed in a range including the stator winding 41 and the wiring module 130. In FIG. 2A, the molded resin portion 150 is formed by integrally performing resin-molding in a range including the coil ends CE1, CE2 in both axial end ranges and the coil side CS. By forming the molded resin portion 150, an insulating layer is formed between the winding segments 81A, 81B and the position restriction members 70, 100.

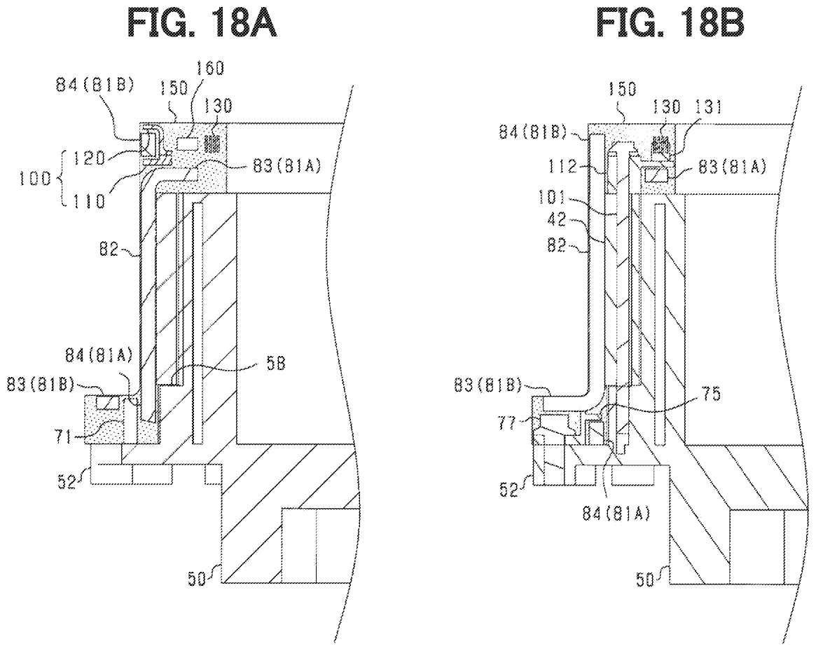

Hereinafter, a configuration related to the molded resin of the stator unit 30 will be described. FIGS. 18A and 18B are cross-sectional views each illustrating the stator unit 30 in a state where the molded resin portion 150 is added to the stator unit 30, and FIG. 18A corresponds to FIG. 4A and FIG. 18B corresponds to FIG. 4B.

As illustrated in each of FIGS. 18A and 18B, the molded resin portion 150 is provided to cover a range from the position restriction member 70 in the axial one end range to the position restriction member 100 in the axial other end range, inclusive, and to cover components including the intermediate conductor portions 82 of the winding segments 81A, 81B, in the axial direction. In this case, in the coil end CE2, each of the crossover portions 83, 84 of the winding segments 81A, 81B and the position restriction member 70 are arranged in a state of being separated slightly from each other, and each gap formed by the separation is filled with a resin material, thereby forming an insulating layer. In the coil end CE1, each of the crossover portions 83, 84 of the winding segments 81A, 81B and the position restriction member 100 are arranged in a state of being separated slightly from each other, and each gap formed by the separation is filled with a resin material, thereby forming an insulating layer.

In the coil side CS, an insulating layer is formed by filling with a resin material each space between the intermediate conductor portions 82 arranged in the circumferential direction.

In a case where the winding segments 81A, 81B and the position restriction members 70, 100 are assembled to the core assembly CA, each of the crossover portions 83, 84 and each of the position restriction members 70, 100 are brought into a state of being separated from each other, depending on the assembling positions of the winding segments 81A, 81B and the position restriction members 70, 100. Then, each gap formed by the separation is configured to be filled with a resin material.

A configuration is preferably made in which a resin material (insulating material) is interposed between the stator core 42 and the stator holder 50. This configuration reduces rattling of the stator core 42 with respect to the stator holder 50. As described above, the raised portions and the recessed portions are formed on the portions facing radially inward and outward, in the stator core 42 and the stator holder 50 (see FIG. 5), and the stator core 42 and the stator holder 50 are coupled by projection-recess fitting using the raised portions and the recessed portions. In this case, a configuration is made in which the resin material is interposed in a gap between the two members. The assembling of the stator core 42 to the stator holder 50 may be performed by shrink fitting, pin fixing, or the like, other than the projection-recess fitting described above.

The insulating layers in the coil ends CE1, CE2 and the insulating layers in the coil side CS, that is, the insulating layers axially outward of the stator core 42 and the insulating layers radially inward and outward of the stator core 42 are preferably formed of the same resin material.

At the time of manufacturing the stator unit 30, the gap between the stator core 42 and the stator holder 50 can be used as a passage through which a resin material (insulating material) flows. In this case, passages (resin passages) are preferably formed between the stator core 42 and the stator holder 50. The passages preferably extend in the axial direction while being formed at predetermined intervals in the circumferential direction to allow the resin material to flow therethrough at the time of manufacturing the stator unit 30. For example, a configuration may be made in which a plurality of protrusions is provided in the circumferential direction on the end face 58 of the stator holder 50 to form gaps between the end face 58 of the stator holder 50 and an axial end face of the stator core 42, thereby allowing the resin material to flow through the gaps. A configuration may be made in which, in at least one of the stator core 42 or the stator holder 50, a through-hole extending between both axial end faces is provided to use the through-hole as a resin passage that allows the resin material to flow therethrough at the time of manufacturing the stator unit 30.

However, the insulating layers in the coil ends CE1, CE2 and the insulating layers in the coil side CS may be formed of different resin materials. An insulating material interposed between each of the intermediate conductor portions 82 of the winding segments 81A, 81B and the stator core 42 is preferably a resin material having an adhesive force higher than that of a resin material of the insulating layers in the coil ends CE1, CE2. The resin material may be simultaneously cured in a preheating process during the molding. An insulating material interposed between each of the intermediate conductor portions 82 of the winding segments 81A, 81B and the stator core 42 is preferably a resin material having thermal conductivity higher than thermal conductivity of a resin material of the insulating layers in the coil ends CE1, CE2. The insulating layer between each of the intermediate conductor portions 82 and the stator core 42 is preferably formed of, for example, a resin having thermal conductivity of equal to or higher than 0.3 W/mK.

As illustrated in FIG. 18A, a temperature detector 160 that detects the temperature of the stator 40 is preferably provided in the molded resin portion 150. That is, a configuration is preferably made in which the temperature detector 160 is provided integrally with, for example, the position restriction member 100 or the wiring module 130 to subject these components collectively to resin-molding.

The molded resin portion 150 is simply required to be provided in at least the coil ends CE1, CE2. That is, a configuration may be made in which the molded resin portion 150 is not provided in the coil side CS.

According to the present embodiment described in detail above, the following excellent effects can be obtained.

In the stator unit 30 including the position restriction members 70, 100 that restrict the positions of the winding segments 81A, 81B, a concern may arise that the insulation property of the stator winding 41 could be impaired along with contact between each of the winding segments 81A, 81B and each of the position restriction members 70, 100, in a case where a configuration is made in which the position restriction members 70, 100 formed of metal are used from the viewpoint of rigidity. With respect to this concern, the configuration is employed in which the molded resin portion 150 is provided and the insulating layer is interposed between each of the winding segments 81A, 81B and each of the position restriction members 70, 100. Thus, a decrease in the insulation property can be reduced. As a result, the insulation state of the stator winding 41 can be appropriately maintained.

In the coil ends CE1, CE2, the parts of the position restriction members 70, 100 are placed into respective regions annularly inward with respect to the crossover portions 83, 84, whereby the positions can be restricted in two different directions, in each of the winding segments 81A, 81B. Then, the insulating layer is interposed between each of the crossover portions 83, 84 and each of the position restriction members 70, 100, whereby a decrease in the insulation property of the winding segments 81A, 81B caused by the position restriction members 70, 100 can also be reduced.

Each of the winding segments 81A, 81B is considered to be formed in an annular shape by winding a conductor material a plurality of times on the inner peripheral basis. In this case, in the configuration where each of the position restriction members 70, 100 is placed at respective positions annularly inward with respect to the crossover portions 83, 84, tolerance design and the like of the winding segments 81A, 81B are facilitated in a case of designing a separation distance (insulation distance) between each of the crossover portions 83, 84 and each of the position restriction members 70, 100.

As the winding segments 81A, 81B, the winding segments 81A, 81B including the crossover portions 83, 84 in the coil ends CE1, CE2 having different shapes are used, whereby the winding segments 81A, 81B can be arranged in a state of overlapping with each other in the circumferential direction without interfering with each other. In this case, the configuration is made in which the positions of the winding segments 81A, 81B are commonly restricted by using the common position restriction members 70, 100. Thus, the number of components can be reduced and the configuration can be simplified.

In a case where the winding segments 81A, 81B are arranged in a state of overlapping with each other in the circumferential direction while being in a state where one of the winding segments 81A, 81B is bent in the radial direction in each of the coil ends CE1, CE2, the crossover portions 83, 84 are arranged close to each other, in the winding segments 81A, 81B. In view of this point, each of the position restriction members 70, 100 is provided in a state of being placed into the respective regions annularly inward with respect to the crossover portions in the winding segments 81A and the respective regions annularly inward with respect to the crossover portions in the winding segments 81B. As a result, the positions can be easily restricted in a plurality of directions, in each of the winding segments 81A, 81B.

In the coil end CE1, the position restriction member 100 is configured to be in a state of being placed into the respective regions annularly inward with respect to the crossover portions 83 in the winding segments 81A while being in a state of facing the crossover portions 84 in the winding segments 81B from an axially outer position with respect to the crossover portion 84. In this case, in the coil end CE1, the position restriction member 100 can be assembled while taking into consideration the bent states of the crossover portions 83, 84 in the winding segments 81A, 81B.

The position restriction member 100 is configured to include the portions (restriction portions 113, 122) sandwiching circumferentially-extending portions in the crossover portions 84 of the winding segments 81B from respective annularly outer positions and respective annularly inner positions with respect to the circumferentially-extending portions. In this case, the crossover portions 84 of the winding segments 81B are axially sandwiched by the position restriction member 100, and thus the axial positions can be appropriately restricted.

In the configuration where the crossover portions 83, 84 of the plurality of winding segments 81A, 81B are arranged in the circumferential direction, the position restriction member 100 having a circular annular shape is configured to be provided in a state of facing the crossover portions 83, 84 arranged in the circumferential direction, and the wiring module 130 having a circular annular shape is configured to be fixed to the position restriction member 100 (specifically, the second annular member 120). As a result, the electrical connection between each of the winding segments 81A, 81B arranged in the circumferential direction and the wiring module 130 can be suitably achieved while the number of components can be reduced.

In each of the coil ends CE1, CE2, in a range including the crossover portions 83, 84 of the winding segments 81A, 81B and the position restriction members 70, 100, these members are integrally subjected to resin-molding. In this case, the molded resin portion 150 is formed using the same resin material in each of the coil ends CE1, CE2. As a result, the insulating layer can be appropriately formed in a portion facing the position restriction members 70, 100 around the crossover portions 83, 84 of the winding segments 81A, 81B (the gap between each of the crossover portions and each of the position restriction member).

The components including the position restriction members 70, 100 in both axial end ranges and the intermediate conductor portions 82 of the winding segments 81A, 81B, in the axial direction, are configured to be subjected to resin-molding. As a result, the molded resin portion 150 is formed in a range including the entire winding segments 81A, 81B, and an unintended decrease in insulation in the winding segments 81A, 81B can be appropriately reduced.

In a case where the insulating layers in the coil ends CE1, CE2 and the insulating layers in the coil side CS are formed of different resin materials, a resin material is used that has an adhesive force higher than that of a resin material of the insulating layers in the coil ends CE1, CE2, for the insulating material interposed between each of the intermediate conductor portions 82 of the winding segments 81A, 81B and the stator core 42. As a result, strength in assembling the winding segments 81A, 81B to the stator core 42 can be increased, and the positional displacement of the winding segments 81A, 81B can be suitably reduced.

Likewise, in a case where the insulating layers in the coil ends CE1, CE2 and the insulating layers in the coil side CS are formed of different resin materials, a resin material is used that has thermal conductivity higher than that of a resin material of the insulating layers in the coil ends CE1, CE2, for the insulating material interposed among each of the intermediate conductor portions 82 of the winding segments 81A, 81B, the stator core 42, and the stator holder 50. As a result, cooling performance in the intermediate conductor portions 82 can be improved.

The temperature detector 160 is subjected to resin-molding integrally with the crossover portions 83, 84 of the winding segments 81A, 81B and the position restriction member 100. As a result, both heat transfer to the temperature detector 160 and fixing of the temperature detector 160 can be achieved by the molded resin portion 150.

The insulating material forming the insulating layer is interposed between the stator core 42 and the stator holder 50, whereby rattling of the stator core 42 with respect to the stator holder 50 can be reduced. In this case, at the time of manufacturing the stator unit 30, the gap between the stator core 42 and the stator holder 50 is used as a passage through which an insulating material (resin material) flows, whereby formation of the insulating layers (resin-molding) can be easily performed in the coil ends CE1, CE2 in both axial end ranges.

The passages (resin passages) are preferably formed between the stator core 42 and the stator holder 50. The passages preferably extend in the axial direction while being formed at predetermined intervals in the circumferential direction to allow the insulating material to flow therethrough at the time of manufacturing the stator unit 30.

In a state where the position restriction member 100 overlaps with the axial end face of the stator core 42, the configuration is made in which the fasteners (long bolts 101) are inserted into the through-holes of the stator core 42 and the position restriction member 100, and in which the fasteners are fastened at positions opposite to the position restriction member 100 with respect to the stator core 42. As a result, the stator core 42 and the position restriction member 100 can be simultaneously fixed.

Hereinafter, configurations, and operations and effects of other embodiments will be described while focusing on differences from the first embodiment.

### Second Embodiment

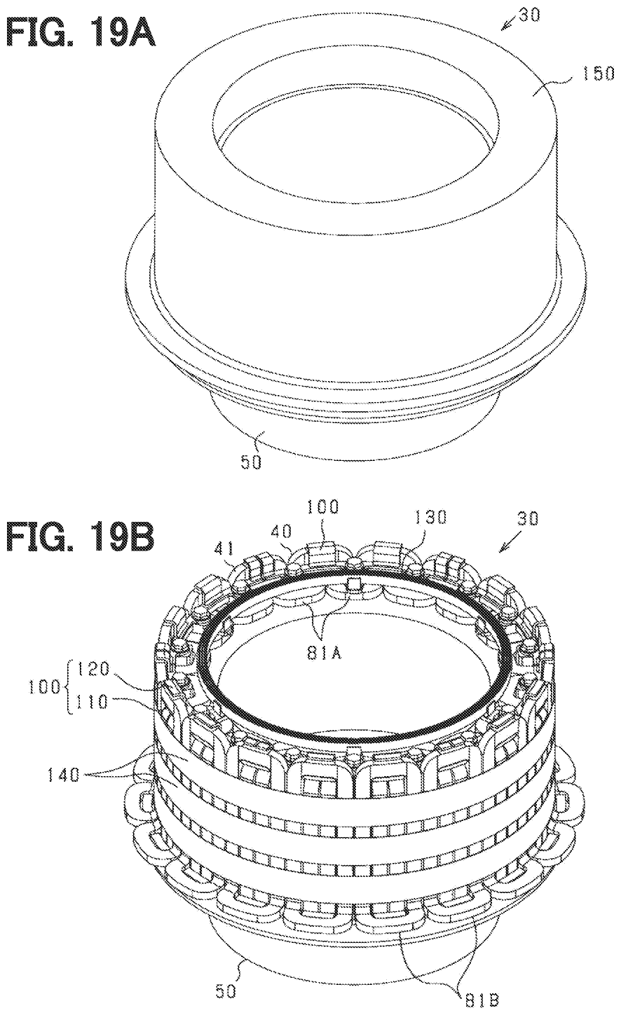

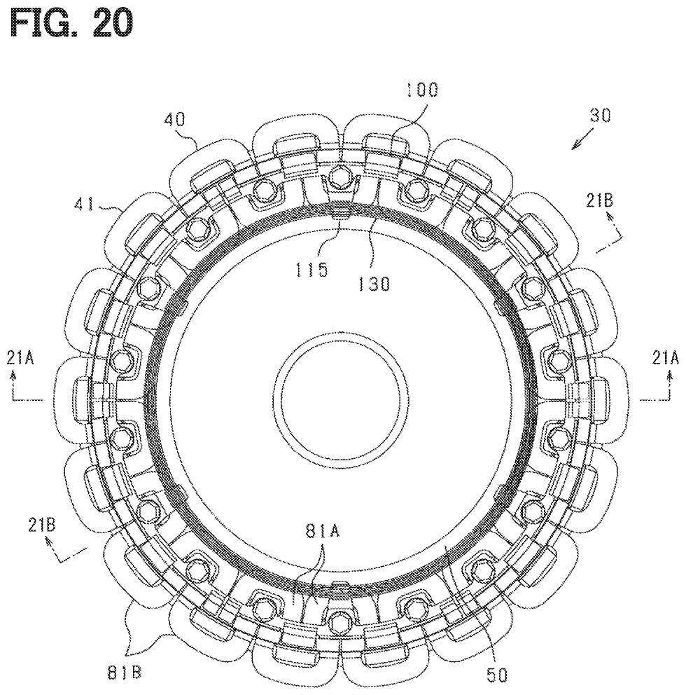

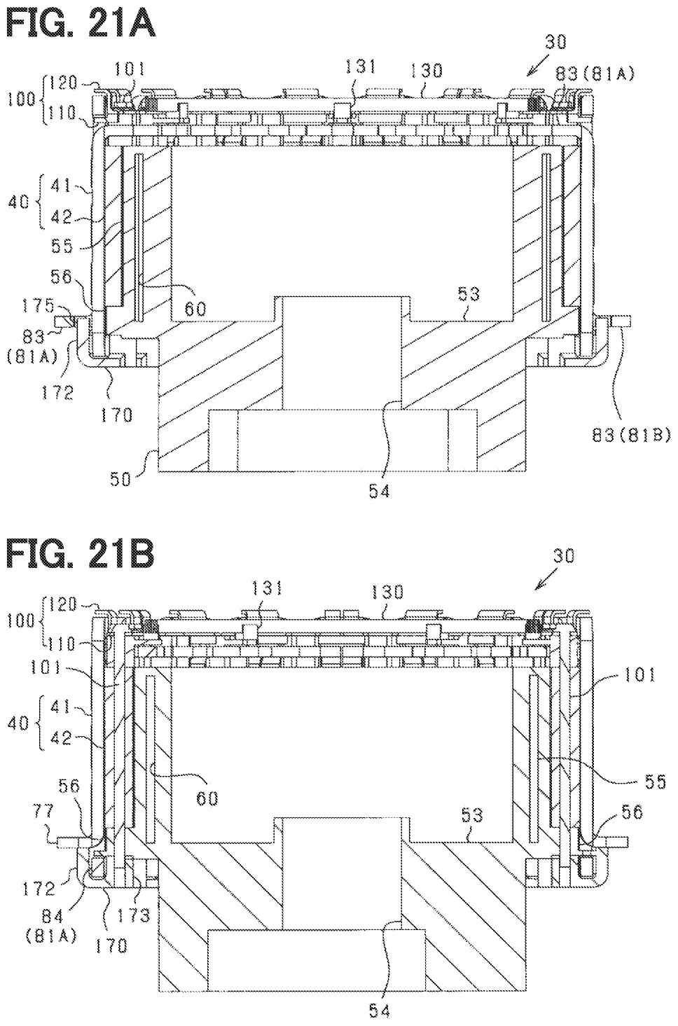

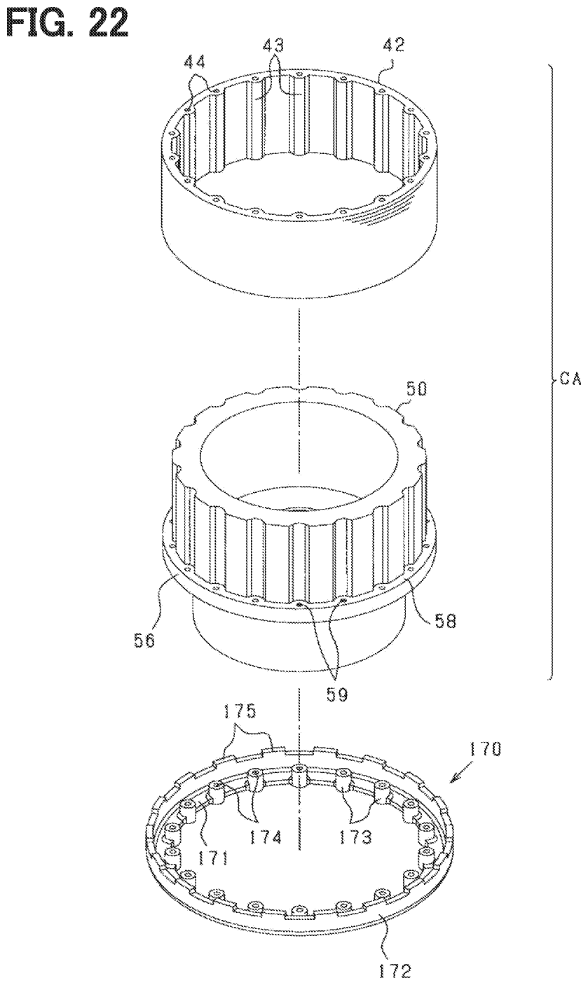

A stator unit 30 according to the present embodiment will be described. The stator unit 30 according to the present embodiment has a difference from that of the first embodiment in that a configuration is changed as to the winding position restriction in the range of the coil end CE2 of the stator unit 30. FIGS. 19A and 19B are perspective views illustrating appearances of the stator unit 30, and FIG. 19B illustrates a state in which a molded resin provided to the stator unit 30 is removed. FIG. 20 is a top view of the stator unit 30. FIG. 21A is a cross-sectional view taken along line 21A-21A in FIG. 20, and FIG. 21B is a cross-sectional view taken along line 21B-21B in FIG. 20. FIG. 22 is a perspective view illustrating a core assembly CA according to the present embodiment and a position restriction member 170 attached to the core assembly CA in the range of the coil end CE2, in an exploded state.

In the present embodiment, the configuration in the range of the coil end CE2 is changed among the configurations as to the winding position restriction in the coil ends CE1, CE2. With this change, the outwardly-extending portion 52 is removed in the stator holder 50 of the core assembly CA. The holes 59 provided in the large-diameter portion 56 are changed to through-holes extending therethrough in the axial direction. However, other configurations related to the core assembly CA are common to those illustrated in FIG. 5 and the like. The configuration of the position restriction member 100 in the range of the coil end CE1 is not changed, and thus the description thereof is omitted.

As illustrated in FIG. 22, the position restriction member 170 is formed in a circular annular shape, and includes an end plate portion 171 axially outward of an axial end face (lower end face in the drawing) of the large-diameter portion 56 of the stator holder 50, and an annular wall portion 172 having a circular annular shape and extending in the axial direction from an outer edge portion of the end plate portion 171. The end plate portion 171 is provided with a plurality of boss portions 173 at predetermined intervals in the circumferential direction. In the boss portions 173, respective through-holes 174 extending therethrough in the axial direction are formed.

The annular wall portion 172 is formed to have a diameter larger than the diameter of the large-diameter portion 56. A plurality of restriction portions 175 extending in the axial direction is provided on the annular wall portion 172. The restriction portions 175 are projecting portions extending in the circumferential direction, and are provided at predetermined intervals in the circumferential direction. The position restriction member 170 is formed of, for example, aluminum, an aluminum alloy, cast iron, or the like.

As illustrated in each of in FIGS. 21A and 21B, in the range of the coil end CE2, the position restriction member 170 is assembled to the stator holder 50 in a state where the boss portions 173 are in contact with the axial end face (lower end face in the drawings) of the large-diameter portion 56 of the stator holder 50. In this state, the annular wall portion 172 of the position restriction member 170 and the large-diameter portion 56 of the stator holder 50 face each other in the radial direction to form an annular groove therebetween, and the crossover portions 84 (unbent crossover portions) of the winding segments 81A are inserted into the annular groove. As a result, the radial and axial positions of the winding segments 81A are restricted in the range of the coil end CE2. Each of the restriction portions 175 of the position restriction member 170 is placed at a position annularly inward with respect to a corresponding one of the crossover portions 83 (bent crossover portions) of the winding segments 81B, whereby the circumferential positions of the winding segments 81B are restricted in the range of the coil end CE2.

A plurality of restriction portions may be provided on the annular wall portion 172, at predetermined intervals in the circumferential direction to extend radially inward. In this case, each of the restriction portions is placed at a position annularly inward with respect to a corresponding one of the crossover portions 84 of the winding segments 81A, whereby the circumferential and axial positions of the winding segments 81A are restricted in the range of the coil end CE2.

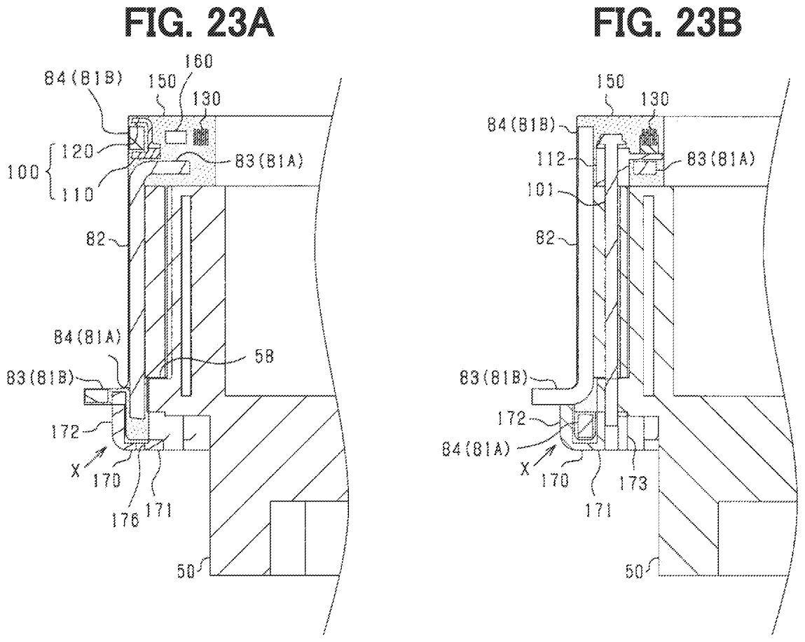

FIGS. 23A and 23B are cross-sectional views each illustrating the stator unit 30 in a state where the molded resin portion 150 is added to the stator unit 30, and FIG. 23A corresponds to FIG. 21A and FIG. 23B corresponds to FIG. 21B.

As illustrated in each of FIGS. 23A and 23B, the molded resin portion 150 is provided to cover a range from the position restriction member 170 in the axial one end range to the position restriction member 100 in the axial other end range, inclusive, and to cover components including the intermediate conductor portions 82 of the winding segments 81A, 81B, in the axial direction. The configuration is substantially the same as the configuration in each of in FIGS. 18A and 18B described above. That is, in each of the coil ends CE1, CE2, a configuration is made in which a resin material enters between each of the crossover portions 83, 84 of the winding segments 81A, 81B and each of the position restriction members 170, 100 to form an insulating layer. A configuration is made in which a resin material (insulating material) is interposed between the stator core 42 and the stator holder 50.

In the range of the coil end CE2, in the position restriction member 170, a portion opposite to the stator holder 50 across the crossover portions 84 of the winding segments 81A and surrounding the crossover portions 84 from radially outside is a molding-free portion free from resin-molding (X portion in FIG. 23). In this case, the portion of the position restriction member 170 is an exposed portion exposed to the outside without being subjected to resin-molding, and heat dissipation performance is improved. That is, in the rotary electric machine 10, for example, oil cooling of the stator 40 can be considered that is performed by dropping lubricating oil into the inside of the rotor carrier 21. In the configuration having such an oil cooling structure, the molding-free portion (exposed portion) of the position restriction member 170 is a heat dissipation portion through which heat is dissipated by oil cooling.

As illustrated in FIG. 23A, in the end plate portion 171 axially outward of the axial end face of the stator holder 50, in the position restriction member 170, holes 176 passing therethrough in the axial direction may be provided. The holes 176 are preferably provided at positions not interfering with the boss portions 173. In this case, the annular groove surrounding the large-diameter portion 56 of the stator holder 50 can be filled with a resin material from the holes 176. Thus, an insulating layer can be appropriately formed in the circumferential vicinity of the position restriction member 170.

### Third Embodiment

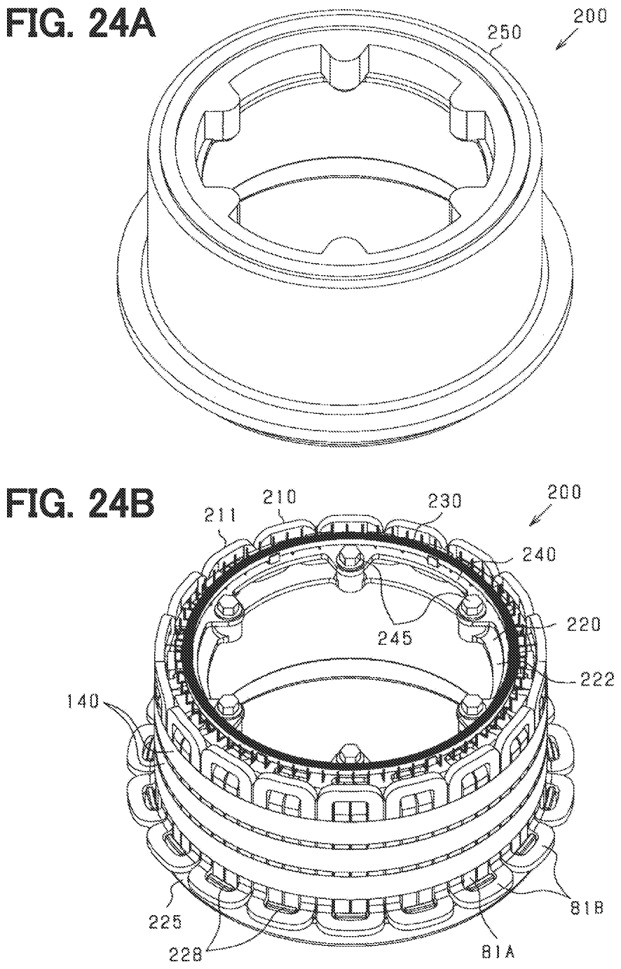

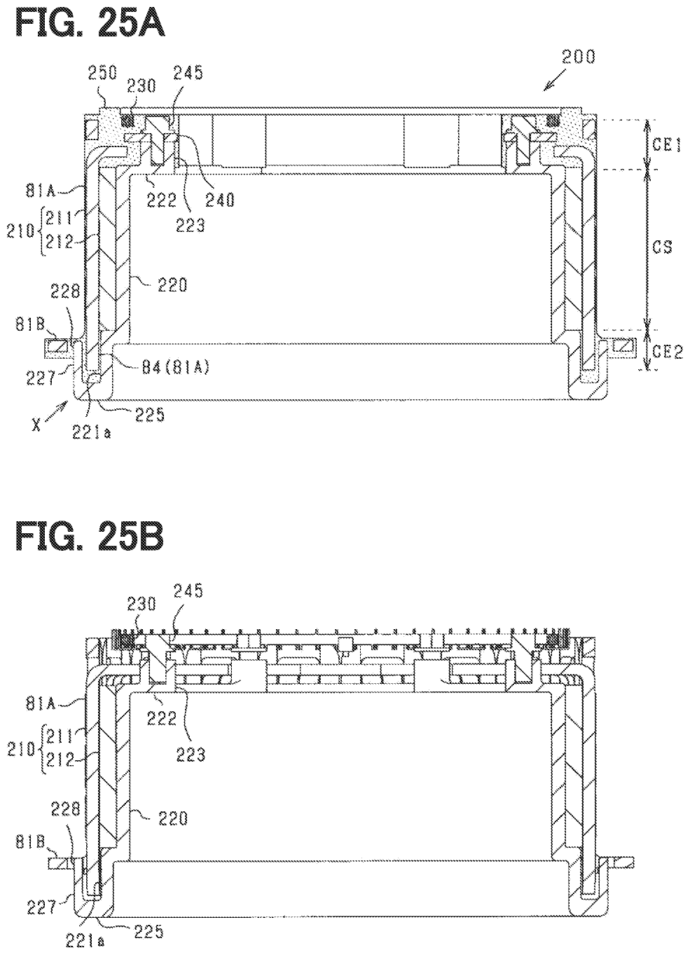

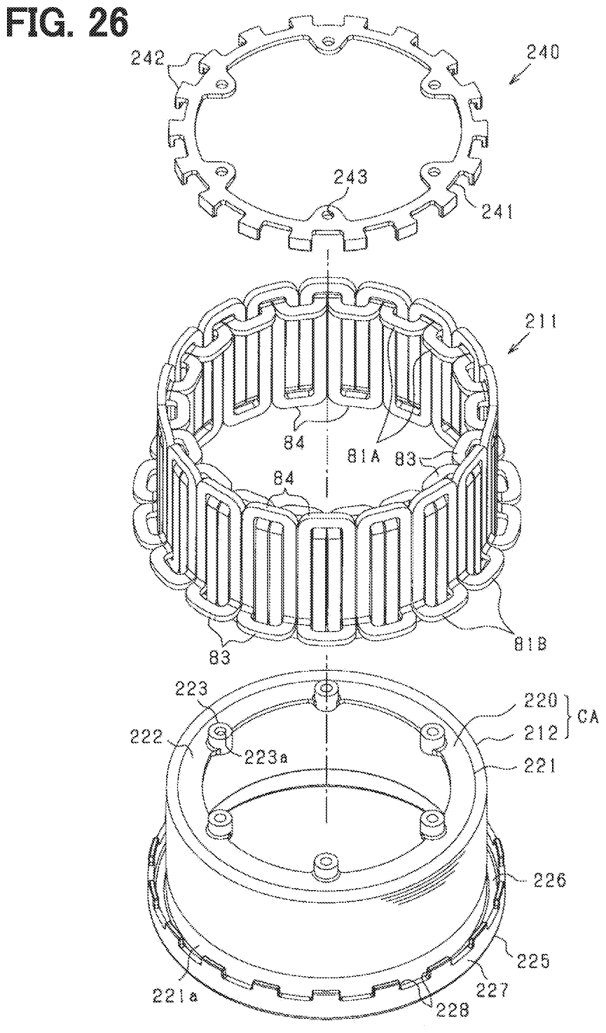

A stator unit 200 according to the present embodiment will be described. FIGS. 24A and 24B are perspective views illustrating appearances of the stator unit 200, and FIG. 24A illustrates the stator unit 200 in a state of being subjected to resin-molding and FIG. 24B illustrates the stator unit 200 in a state of being not subjected to resin-molding. FIG. 25A is a longitudinal cross-sectional view of the stator unit 200 in a state of being subjected to resin-molding, and FIG. 25B is a longitudinal cross-sectional view of the stator unit 200 in a state of being not subjected to resin-molding. FIG. 26 is a perspective view illustrating main configurations in an exploded state, in the stator unit 200.

The stator unit 200 mainly includes a stator 210, a stator holder 220 provided radially inward of the stator 210, and a wiring module 230. The stator 210 has a toothless structure, and includes a stator winding 211 and a stator core 212. A configuration is made by integrating the stator core 212 and the stator holder 220 to provide these components as a core assembly CA (see FIG. 26), and by assembling the stator winding 211 to the core assembly CA.

The stator 210 has a configuration substantially similar to that of the stator 40 described above, and the stator winding 211 includes the plurality of winding segments 81A, 81B as described above. The stator core 212 has a configuration substantially similar to that of the stator core 42 except that the stator core 212 does not include a plurality of raised portions on an inner peripheral face thereof. Detailed description of the configurations of the stator 210 similar to those of the stator 40 will be omitted. As illustrated in FIG. 25, a range (upper in the drawing), of both axial end ranges, in which the crossover portions 83 of the winding segments 81A are bent radially inward, is a coil end CE1, and a range (lower in the drawing), of both axial end ranges, in which the crossover portions 83 of the winding segments 81B are bent radially outward, is a coil end CE2. The wiring module 230 has the same configuration as that of the wiring module 130, and thus the description thereof will be omitted.

As illustrated in FIG. 26, the stator holder 220 includes a cylindrical portion 221, and the stator core 212 is assembled to the cylindrical portion 221. A flange portion 222 extending radially inward is formed at an axial end portion in the cylindrical portion 221 in the range of the coil end CE1. The flange portion 222 is provided with a plurality of boss portions 223 at predetermined intervals in the circumferential direction. The boss portions 223 are provided with respective holes 223a extending therethrough in the axial direction. In the holes 223a, respective internal threads are formed.

An outwardly-extending portion 225 extending radially outward with respect to the cylindrical portion 221 is provided at an axial end portion in the cylindrical portion 221 in the range of the coil end CE2. The outwardly-extending portion 225 includes an end plate portion 226 extending radially outward from the cylindrical portion 221 (large-diameter portion 221a) of the stator holder 220, and an annular wall portion 227 having a circular annular shape and extending axially from an outer edge portion of the end plate portion 226. The annular wall portion 227 is formed to have a diameter larger than the diameter of the large-diameter portion 221a. The annular wall portion 227 is provided with a plurality of restriction portions 228 extending in the axial direction. The restriction portions 228 are projecting portions extending in the circumferential direction, and are provided at predetermined intervals in the circumferential direction.

The outwardly-extending portion 225 of the stator holder 220 functions as a position restriction member that restricts the positions of the winding segments 81A, 81B assembled to the core assembly CA, in the range of the coil end CE2.

The stator holder 220 is formed of, for example, metal such as aluminum or cast iron, or a carbon fiber reinforced plastic (CFRP). Although not illustrated, the stator holder 220 preferably includes a cooling medium passage through which a cooling medium such as cooling water flows, similarly to the stator holder 50.

In the range of the coil end CE1, a position restriction member 240 that restricts the positions of the winding segments 81 is attached to the boss portions 223 of the stator holder 220. The position restriction member 240 includes a circular annular portion 241, and a plurality of restriction portions 242 provided on the circular annular portion 241 at predetermined intervals. The restriction portions 242 are provided to extend in the axial direction from the circular annular portion 241. In the circular annular portion 241, a plurality of through-holes 243 extending therethrough in the axial direction is formed as bolt insertion holes. The position restriction member 240 is fixed to the stator holder 220 with bolts 245. The position restriction member 240 is formed of, for example, aluminum, an aluminum alloy, cast iron, or the like.

In the position restriction member 240, the restriction portions 242, which are placed at respective positions annularly inward with respect to the crossover portions 83 of the winding segments 81A, are provided on one of a radially inner side and a radially outer side of the circular annular portion 241, while the through-holes 243 (fixed portions) fixed to the stator holder 220 with the bolts 245 are provided on the other one of the radially inner side and the radially outer side. In this case, the restriction portions 242 and the through-holes 243 (fixed portions) are provided at positions separated radially inward and outward in the position restriction member 240. Thus, the position restriction member 240 can be fixed to the stator holder 220, without causing interference in the position restriction for the crossover portions 83 arranged in the circumferential direction. That is, in the position restriction member 240, if both the restriction portions 242 and the through-holes 243 (fixed portions) are configured to be provided at the radially outer positions, a concern may arise that, for example, the restriction portions 242 could become smaller due to restriction caused by the fixed portions. However, according to the above configuration, the restriction portions 242 can be provided as portions having sufficient strength.

The position restriction for the winding segments 81A, 81B will be described in detail with reference to FIGS. 25 to 27. In the range of the coil end CE2 (lower in the drawing), the large-diameter portion 221a and the annular wall portion 227 of the outwardly-extending portion 225 of the stator holder 220 face each other in the radial direction to form an annular groove therebetween, and the crossover portions 84 (unbent crossover portions) of the winding segments 81A are inserted into the annular groove. As a result, the radial and axial positions of the winding segments 81A are restricted in the range of the coil end CE2. Each of the restriction portions 228 of the outwardly-extending portion 225 is placed at a position annularly inward with respect to a corresponding one of the crossover portions 83 (bent crossover portions) of the winding segments 81B, whereby the circumferential positions of the winding segments 81B are restricted in the range of the coil end CE2.

On the other hand, in the range of the coil end CE1, in a state where the position restriction member 240 is assembled to the stator holder 220, the axial positions of the winding segments 81A are restricted by the circular annular portion 241 of the position restriction member 240. Each of the restriction portions 242 of the position restriction member 240 is placed at a position annularly inward with respect to a corresponding one of the crossover portions 83 of the winding segments 81A, whereby the circumferential and radial positions of the winding segments 81A are restricted in the range of the coil end CE1.

In the present embodiment, in the range of the coil end CE1, the position restriction member 240 (first position restriction member), which is a member provided separately from the stator holder 220, is configured to be fixed with the bolts 245. In the range of the coil end CE2, the outwardly-extending portion 225 (second position restriction member) is configured to be formed integrally with the stator holder 220, in a state of extending in the radial direction. According to this configuration, in a case where the winding segments 81A, 81B are assembled to the stator holder 220, first, the winding segments 81A, 81B can be assembled in a state of being positionally restricted by the outwardly-extending portion 225 formed integrally with the stator holder 220, and thereafter, the position restriction member 240 can be subsequently attached to the assembly including the stator holder 220 and the winding segments 81A, 81B. In this case, by forming one of the position restriction members in both axial end ranges integrally with the stator holder 220, the positions of the winding segments 81A, 81B can be appropriately restricted while the number of components can be reduced and an assembling operation can be simplified.

As illustrated in FIG. 24A, in the stator unit 200 of the present embodiment, a molded resin portion 250 is formed in a range including the stator winding 211 and the wiring module 230. A configuration of the molded resin portion 250 will be described with reference to FIG. 25A.

The molded resin portion 250 is provided to cover a range from the outwardly-extending portion 225, which is the position restriction member in the axial one end range, to the position restriction member 240 in the axial other end range, inclusive, and to cover components including the intermediate conductor portions 82 of the winding segments 81A, 81B, in the axial direction. In this case, in each of the coil ends CE1, CE2, a configuration is made in which a resin material enters between each of the crossover portions 83, 84 of the winding segments 81A, 81B and each of the outwardly-extending portion 225 and the position restriction member 240 to form an insulating layer.

In the range of the coil end CE2, in the outwardly-extending portion 225, a portion opposite to the stator holder 220 across the crossover portions 84 of the winding segments 81A and surrounding the crossover portions 84 from radially outside is a molding-free portion free from resin-molding (X portion in in FIG. 25A). In this case, the portion of the outwardly-extending portion 225 is an exposed portion exposed to the outside without being subjected to resin-molding, and heat dissipation performance is improved.

When the winding segments 81A, 81B are compared with each other, the crossover portions 83 are bent radially inward in the winding segments 81A, and the crossover portions 83 are bent radially outward in the winding segments 81B. In this case, the winding segment 81A is considered to have a shorter conductor length, whereby a conductor resistance is considered to be lower, thereby causing the amount of heat generation to become larger. However, in the above configuration, the crossover portions 83 of the winding segments 81A are accommodated in the annular groove formed by the outwardly-extending portion 225, and thus the heat dissipation performance is enhanced. Heat dissipation to the cooling medium passage provided in the stator holder 220 is also suitably performed.

### Fourth Embodiment

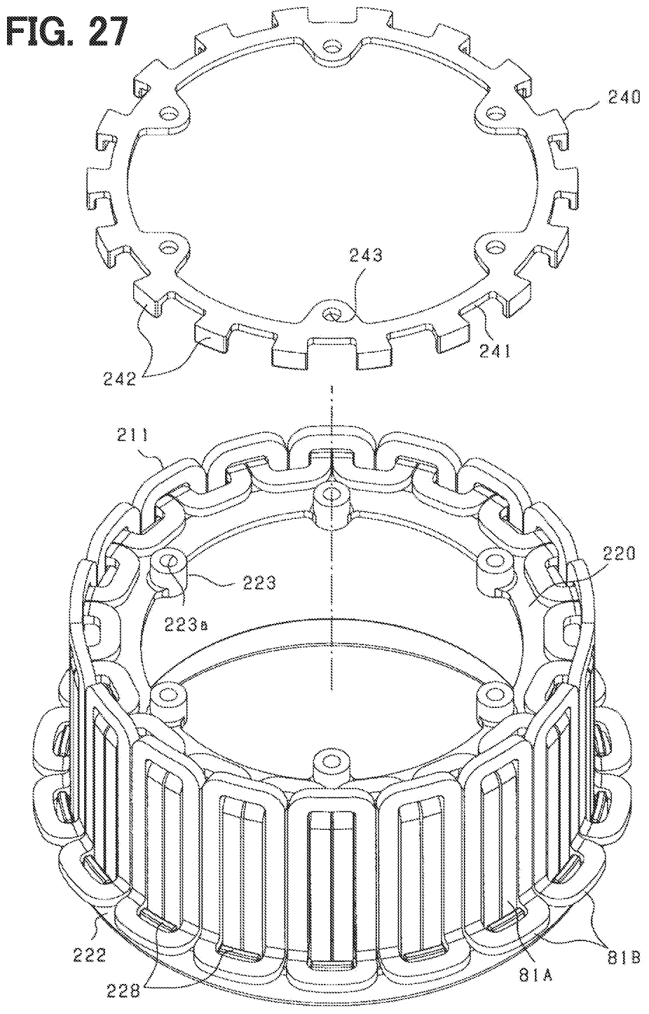

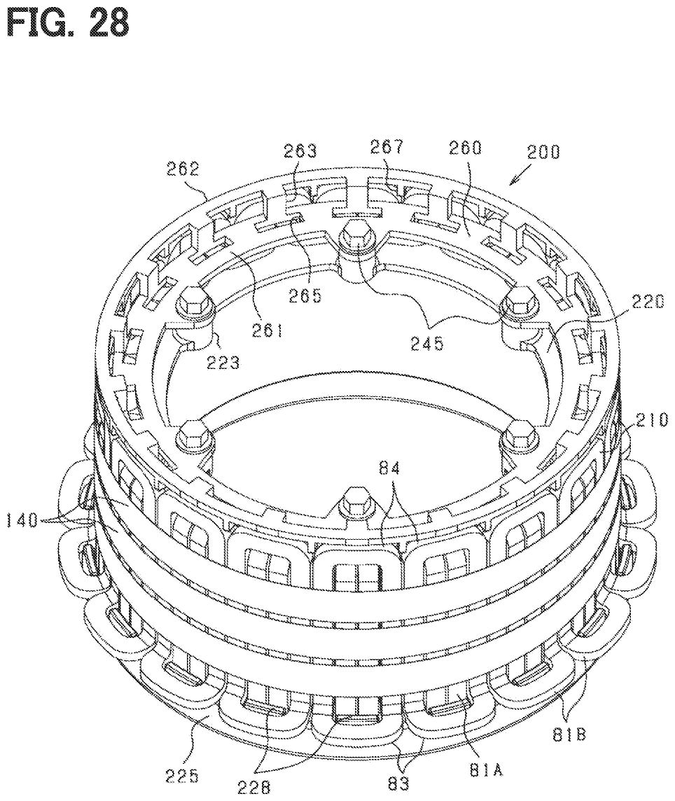

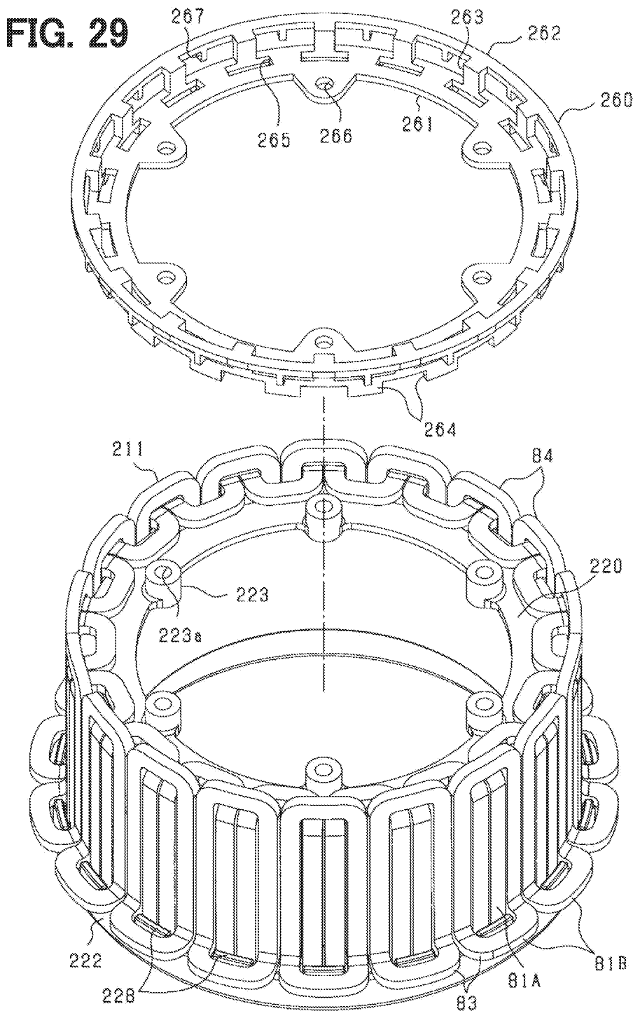

In the present embodiment, part of the stator unit 200 in the third embodiment is changed. FIG. 28 is a perspective view illustrating a configuration of a stator unit 200 according to the present embodiment, and FIG. 29 is a perspective view illustrating a state in which a position restriction member 260 is separated in the stator unit 200 according to the present embodiment. In FIG. 28, for convenience of description, the wiring module and the molded resin are not illustrated. In the present embodiment, in the stator unit 200, the position restriction member 260 is configured to be provided as a position restriction portion in the range of the coil end CE1. The stator unit 200 illustrated in FIG. 28 is different from the stator unit 200 illustrated (b) in FIG. 24 in that the position restriction member 260 is provided instead of the position restriction member 240. However, configurations other than the configuration as to the position restriction member 260 are substantially the same. In FIG. 29, the configurations as to the core assembly CA and the stator winding 211 are the same as those in FIG. 27.

As illustrated in FIG. 29, the position restriction member 260 includes a first circular annular portion 261, a second circular annular portion 262, and a plurality of connection portions 263 connecting the circular annular portions 261, 262 in the axial direction. A plurality of restriction portions 264 extending in the axial direction at predetermined intervals is provided on the first circular annular portion 261, while, in the first circular annular portion 261, a plurality of holes 265, 266 passing therethrough in the axial direction is provided. The holes 265 are provided at the same pitch as that of the restriction portions 264 in the circumferential direction, while the holes 265 are provided to alternate with the restriction portions 264 in the circumferential direction. The holes 266 are provided as bolt insertion holes through which the bolts 245 are inserted. A plurality of restriction portions 267 extending in the axial direction at predetermined intervals is provided on the second circular annular portion 262.

As illustrated in FIG. 28, the position restriction member 260 is assembled to the stator holder 220 in the range of the coil end CE1 (upper in the drawing). In this state, the axial positions of the winding segments 81A are restricted by the first circular annular portion 261 of the position restriction member 260, while the axial positions of the winding segments 81B are restricted by the second circular annular portion 262. Each of the restriction portions 264 of the position restriction member 260 is placed at a position annularly inward with respect to a corresponding one of the crossover portions 83 (bent crossover portions) of the winding segments 81A, whereby the circumferential and radial positions of the winding segments 81A are restricted in the range of the coil end CE1. Each of the restriction portions 267 of the position restriction member 260 is placed between corresponding ones of the crossover portions 84 (unbent crossover portions) of the winding segments 81B arranged in the circumferential direction, whereby the circumferential positions of the winding segments 81B are restricted in the range of the coil end CE1.

In the present embodiment, the position restriction member 260 is configured to be in a state of being placed into respective regions annularly inward with respect to the crossover portions 83 in the winding segments 81A while being in a state of facing respective regions annularly outward with respect to the crossover portions 84 in the winding segments 81B. In this case, the position restriction member 260 can be assembled while taking into consideration the bent states of the crossover portions 83, 84 in the winding segments 81A, 81B. The position restriction member 260 can be assembled from the axial direction after the assembling of the winding segments 81A, 81B, and a manufacturing operation can be facilitated.

In the first circular annular portion 261 of the position restriction member 260, the holes 265 passing therethrough in the axial direction are provided. Thus, a flow of a resin material is promoted from an axially outer side to an axially inner side of the first circular annular portion 261 at the time of manufacturing the stator unit 200 (at the time of molding). As a result, resin-molding is performed in a range including the inside of the holes 265 and both axially opposite ranges of the first circular annular portion 261. In this case, the resin material reliably flows between each of the crossover portions 83, 84 of the winding segments 81A, 81B and the position restriction member 260, and formation of the molded resin portion 250 (formation of the insulating layer) can be appropriately performed.

### Fifth Embodiment

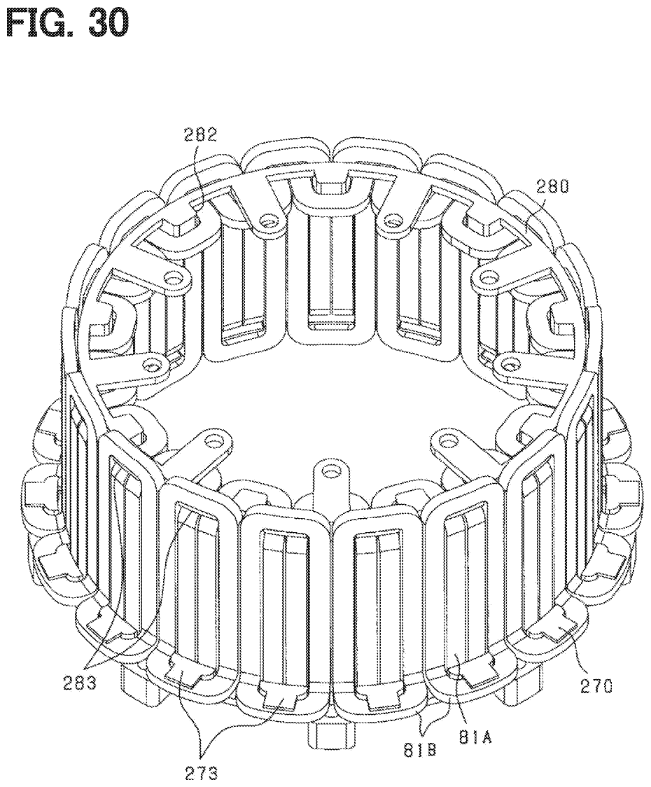

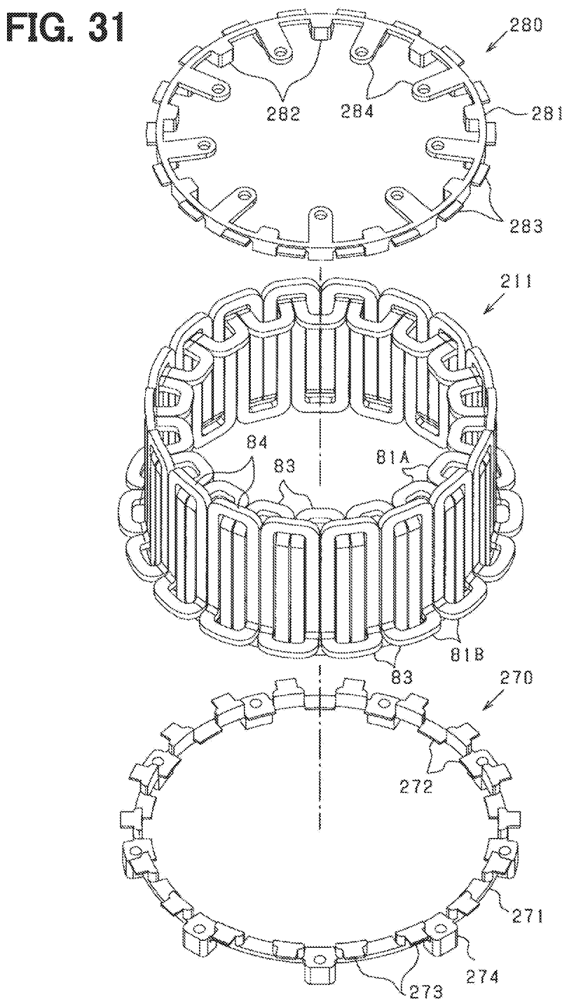

In the present embodiment, part of the stator unit 200 in the third embodiment is changed. FIG. 30 is a perspective view illustrating a configuration of a stator unit 200 according to the present embodiment, and FIG. 31 is a perspective view illustrating a state in which position restriction members 270, 280 are separated in the stator unit 200 according to the present embodiment. In FIG. 30, for convenience of description, the wiring module, the stator holder, and the molded resin are not illustrated. In the present embodiment, in the stator unit 200, the position restriction member 270 is configured to be provided as a position restriction portion in the range of the coil end CE2, and the position restriction member 280 is configured to be provided as a position restriction portion in the range of the coil end CE1. The configuration of the stator winding 211 is the same as the configuration described above.

As illustrated in FIG. 31, the position restriction member 270 includes a circular annular portion 271, a plurality of restriction portions 272 extending radially inward from the circular annular portion 271, and a plurality of restriction portions 273 extending axially from the circular annular portion 271. Each of the restriction portions 273 extends in the axial direction from the circular annular portion 271, and has a shape bent at a tip end range thereof and further extending radially outward. The circular annular portion 271 is provided with protruding portions 274 extending in the axial direction, as portions to be attached to the stator holder (not illustrated).

The position restriction member 280 includes a circular annular portion 281, a plurality of restriction portions 282 extending axially from the circular annular portion 281, and a plurality of restriction portions 283 extending radially outward from the circular annular portion 281. The circular annular portion 281 is provided with protruding portions 284 extending radially inward, as portions to be attached to the stator holder (not illustrated).

As illustrated in FIG. 30, the position restriction member 270 is assembled to the stator holder 220 in the range of the coil end CE2 (lower in the drawing). In this state, each of the restriction portions 272 of the position restriction member 270 is placed at a position annularly inward with respect to a corresponding one of the crossover portions 84 (unbent crossover portions) of the winding segments 81A, whereby the axial and circumferential positions of the winding segments 81A are restricted in the range of the coil end CE2. Each of the restriction portions 273 of the position restriction member 270 is placed at a position annularly inward (bent crossover portions) with respect to a corresponding one of the crossover portions 83 of the winding segments 81B, whereby the axial and circumferential positions of the winding segments 81B are restricted in the range of the coil end CE2.

The position restriction member 280 is assembled to the stator holder 220 in the range of the coil end CE1 (upper in the drawing). In this state, each of the restriction portions 282 of the position restriction member 280 is placed at a position annularly inward with respect to a corresponding one of the crossover portions 83 (bent crossover portions) of the winding segments 81A, whereby the circumferential and radial positions of the winding segments 81A are restricted in the range of the coil end CE1. Each of the restriction portions 283 of the position restriction member 280 is placed at a position annularly inward with respect to a corresponding one of the crossover portions 84 (unbent crossover portions) of the winding segments 81B, whereby the axial and circumferential positions of the winding segments 81B are restricted in the range of the coil end CE1.

### Other Modifications

In each of the above embodiments, in the coil ends CE1, CE2 in both axial end ranges, the molded resin portion is configured to be formed. However, the configuration may be changed to a configuration in which the molded resin portion is formed in one of the coil ends.
In each of the above embodiments, in the coil ends CE1, CE2 in both axial end ranges, the respective position restriction members each of which restricts the positions of the winding segments 81A, 81B are configured to be provided. However, the position restriction member may be configured to be provided in one of the coil ends. In this case, a configuration is preferably made in which the positions of the winding segments 81A, 81B are restricted only in the axial one end range, and in which the winding segments 81A, 81B are restrained by the coil cover 140.
In each of the above embodiments, the stator units 30, 200 includes the stator cores 42, 212, respectively. However, the configurations may be changed to respective configurations in which the respective stator cores 42, 212 are not included. In this case, the winding segments 81A, 81B are assembled to each of the stator holders 50, 220. In the coil side CS, an insulating layer (resin material) is preferably interposed between each of the intermediate conductor portions 82 of the winding segments 81A, 81B and each of the stator holders 50, 220.
The configurations of the winding segments 81A, 81B can be changed.

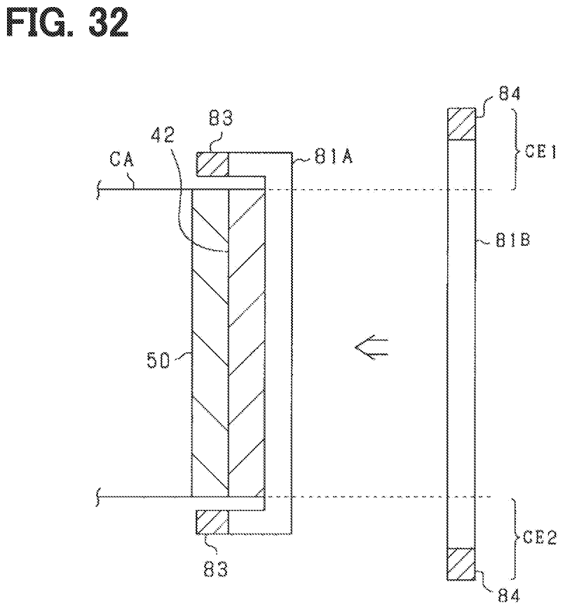

In the configuration illustrated in FIG. 32, a winding segment 81A that is one of two types of winding segments 81A, 81B has a substantially C-shape in lateral view, and a winding segment 81B that is the other one of the two types of winding segments 81A, 81B has a substantially I-shape in lateral view. Of the winding segments 81A, 81B, the winding segment 81A is attached in advance to the core assembly CA and the winding segment 81B is subsequently attached to the core assembly CA. Then, in each of the coil ends CE1, CE2 in both axial end ranges, a corresponding one of position restriction members is assembled to the crossover portions of the winding segments 81A, 81B, and the crossover portions and the position restriction members are collectively subjected to resin-molding.
In each of the above embodiments, in the range of the coil end CE1, the axial end face of the stator core 42 and the axial end face of the stator holder 50 are flush with each other, and the axial end face of the stator core 212 and the axial end face of the stator holder 220 are flush with each other. However, these configurations may be changed. For example, in the range of the coil end CE1, the axial end faces of the stator holders 50, 220 may be configured to protrude in the axial direction with respect to the axial end faces of the stator cores 42, 212, respectively. In this case, an effect of improving heat dissipation performance can be expected.
The stator winding 41 in the rotary electric machine 10 may have a configuration including two-phase windings (a U-phase winding and a V-phase winding). In this case, a configuration is simply required in which, for example, in the winding segments 81, each pair of intermediate conductor portions 82 are provided to be separated from each other by a distance of one coil pitch, and in which a corresponding single intermediate conductor portion 82 in the other one-phase winding segment 81 is arranged between the pair of intermediate conductor portions 82.
In each of the above embodiments, a surface-magnet-type rotor is used as the rotor 20. However, instead of this, an embedded-magnet-type rotor may be configured to be used.
In each of the above embodiments, the rotary electric machine 10 has an outer-rotor structure. However, this structure may be changed such that the rotary electric machine 10 may be a rotary electric machine having an inner-rotor structure. In the rotary electric machine having an inner-rotor structure, a stator is provided at a radially outer position, and a rotor is provided at a radially inner position.
As the rotary electric machine 10, instead of a revolving-field-type rotary electric machine in which a field element is a rotor and an armature is a stator, a revolving-armature-type rotary electric machine can also be adopted in which an armature is a rotor and a field element is a stator.
The rotary electric machine 10 may be used in various purposes other than use as a motor for traveling of a vehicle. The rotary electric machine 10 may be a rotary electric machine widely used in a mobile body including an aircraft, or a rotary electric machine used in an electric device for industrial use or household use.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A rotary electric machine comprising:
a field element having magnetic poles;
an armature having a toothless structure, the armature including an armature winding being multiphase;
an armature holder holding the armature;
a position restriction member being a part of the armature holder or fixed to the armature holder, the position restriction member being located on a coil end of the armature and restricting movement of the armature winding; and
an insulating layer insulating the armature winding from the position restriction member, wherein
the armature winding includes winding segments forming phase windings for respective phases,
each of the winding segments has an annular shape and includes
a pair of intermediate conductor portions separated at a predetermined interval in a circumferential direction of the armature, and
crossover portions provided on one end and another end of the pair of intermediate conductor portions in an axial direction of the armature, the crossover portions connecting the pair of intermediate conductor portions to form the annular shape,
different pairs of intermediate conductor portions of the winding segments are arranged in the circumferential direction and close to each other,
the position restriction member restricts movement of the winding segments attached to the armature holder, and
the insulating layer is interposed between each of the winding segments and the position restriction member.

2. The rotary electric machine according to claim 1, wherein
the position restriction member on the coil end is inserted into an annular winding segment of the armature winding on an annularly inner side of a crossover portion of the annular winding segment, and
the insulating layer is interposed between the crossover portion and the position restriction member.

3. The rotary electric machine according to claim 2, wherein
the winding segments of the armature winding include a first winding segment and a second winding segment, the crossover portions on the coil end being different in shape between the first winding segment and the second winding segment,
at least one of the first winding segment or the second winding segment is bent in an radial direction of the armature on the coil end,
the first winding segment and the second winding segment are overlapped in the circumferential direction, and
the position restriction member is a common member that commonly restricts movement of the first winding segment and movement of the second winding segment.

4. The rotary electric machine according to claim 3, wherein
the position restriction member is inserted into the first winding segment on an annularly inner side of a crossover portion of the first winding segment, and
the position restriction member is inserted into the second winding segment on an annularly inner side of a crossover portion of the second winding segment.

5. The rotary electric machine according to claim 3, wherein
the position restriction member is a separate member from the armature holder and fixed to the armature holder with a fastener,
the position restriction member is inserted into the first winding segment on an annularly inner side of a crossover portion of the first winding segment, and
the position restriction member faces an outer side of a crossover portion of the second winding segment in the axial direction.

6. The rotary electric machine according to claim 3, wherein
the position restriction member is a separate member from the armature holder and fixed to the armature holder with a fastener,
a crossover portion of the first winding segment is bent in the radial direction on the coil end,
a crossover portion of the second winding segment is unbent in the radial direction on the coil end,
the position restriction member is inserted into the first winding segment on an annularly inner side of the crossover portion of the first winding segment, and
the position restriction member faces an annularly outer side of the crossover portion of the second winding segment.

7. The rotary electric machine according to claim 6, wherein
the crossover portion of the second winding segment has a circumferentially extending portion that extends in the circumferential direction, and
the position restriction member includes a first portion and a second portion that face, respectively, an annularly outer side and an annularly inner side of the circumferentially extending portion of the crossover portion of the second winding segment.

8. The rotary electric machine according to claim 1, wherein
the position restriction member is a separate member from the armature holder and fixed to the armature holder with a fastener,
the position restriction member includes an annular portion having an annular shape, and
the position restriction member includes
a restriction portion provided on one of an inner side and an outer side of the annular portion in a radial direction of the armature and inserted into an annular winding segment of the armature winding on an annularly inner side of a crossover portion of the annular winding segment, and
a fixed portion provided on another of the inner side or the outer side of the annular portion in the radial direction and fixed to the armature holder with the fastener.

9. The rotary electric machine according to claim 1, wherein
crossover portions of the winding segments are arranged in the circumferential direction,
the position restriction member has an annular shape and faces the crossover portions arranged in the circumferential direction, and
the rotary electric machine further comprises a wiring module having an annular shape and being electrically connected to each of the winding segments and fixed to the position restriction member.

10. The rotary electric machine according to claim 1, wherein
the insulating layer forms a molded resin located on at least one of opposite coil ends of the armature and integrated with a crossover portion of each of the winding segments and the position restriction member, the molded resin being in contact with a region including the crossover portion of each of the winding segment and the position restriction member.

11. The rotary electric machine according to claim 10, wherein
the position restriction member includes an annular portion having an annular shape,
the annular portion includes a through-hole extending through the annular portion in the axial direction, and
the molded resin is in contact with a region including an inside of the through-hole and both sides of the annular portion facing in the axial direction.

12. The rotary electric machine according to claim 10, wherein
the position restriction member has a molding-free portion that is not covered by the molded resin, and
the molding-free portion faces away from the crossover portion located between the position restriction member and the armature holder and surrounds the crossover portion.

13. The rotary electric machine according to claim 10, wherein
the position restriction member is one of position restriction members located on an one end and another end of the armature holder in the axial direction,
the molded resin is in contact with a region extending from one of the position restriction members located on the one end of the armature holder in the axial direction to another of the position restriction members located on the other end of the armature holder in the axial direction, and
the molded resin is in contact with a component including the pair of intermediate conductor portions of each of the winding segments.

14. The rotary electric machine according to claim 10, wherein
the armature includes an armature core provided inward or outward of the armature winding in a radial direction of the armature,
the rotary electric machine further comprises an insulating material interposed between the armature core and the pair of intermediate conductor portions of each of the winding segments, and
the insulating material is a resin material having an adhesive force higher than an adhesive force of a resin material of the insulating layer located on the coil end.

15. The rotary electric machine according to claim 10, wherein
the armature includes an armature core provided inward or outward of the armature winding in a radial direction of the armature,
the rotary electric machine further comprises an insulating material interposed between the armature core and the pair of intermediate conductor portions of each of the winding segments, and
the insulating material is a resin material having thermal conductivity higher than thermal conductivity of a resin material of the insulating layer located on the coil end.

16. The rotary electric machine according to claim 10, further comprising
a temperature detector configured to detect a temperature of the armature, wherein
the molded resin is in contact with the temperature detector, the crossover portion and the position restriction member.

17. The rotary electric machine according to claim 1, wherein
the position restriction member is one of a first position restriction member located on a first coil end of the armature holder in the axial direction and a second position restriction member located on a second coil end of the armature holder in the axial direction,
the first position restriction member is a separate member from the armature holder and fixed to the armature holder with a fastener, and
the second position restriction member is integrated with the armature holder and extends outward from the armature holder in a radial direction of the armature.

18. The rotary electric machine according to claim 17, wherein
the winding segments of the armature winding include a first winding segment having a bent crossover portion bent in the radial direction on the second coil end, and a second winding segment having an unbent winding segment including an unbent crossover portion unbent in the radial direction on the second coil end,
the second position restriction member includes an annular wall portion having an annular shape and facing a cylindrical portion of the armature holder in the radial direction, and
the unbent crossover portion is inserted into an annular groove formed between the cylindrical portion and the annular wall portion.

19. The rotary electric machine according to claim 18, wherein
the annular wall portion includes restriction portions arranged at predetermined intervals in the circumferential direction and extending in the axial direction, and
one of the restriction portions of the second position restriction member is inserted into the second winding segment on an annularly inner side of the bent crossover portion.

20. The rotary electric machine according to claim 1, wherein
the armature includes an armature core provided inward or outward of the armature winding in a radial direction of the armature,
the armature core faces the armature holder in the radial direction, and
the insulating layer includes an insulating material interposed between the armature core and the armature holder.

21. The rotary electric machine according to claim 1, wherein
the armature includes an armature core provided inward or outward of the armature winding in a radial direction of the armature,
the position restriction member is a separate member from the armature holder,
the armature core has a through-hole extending in the axial direction through the armature core,
the position restriction member has a through-hole extending in the axial direction through the position restriction member,
the position restriction member is placed on an end face of the armature core in the axial direction,
the rotary electric machine further comprises a fastener inserted into the through-hole of the armature core and the through-hole of the position restriction member, and
the fastener has a fastened portion at which the fastener is fastened such that the armature core is located between the position restriction member and the fastened portion.
